(19) United States
(12) Patent Application Publication
(10) Pub. No.: US 2025/0183722 A1
(43) Pub. Date: Jun. 5, 2025

(54) WIRELESS POWER TRANSMISSION APPARATUS FOR WIRELESSLY TRANSMITTING POWER AND OPERATING METHOD THEREOF

(71) Applicant: Samsung Electronics Co., Ltd., Suwon-si (KR)

(72) Inventors: Jaeseok PARK, Suwon-si (KR); Beomwoo GU, Suwon-si (KR); Jaehyun PARK, Suwon-si (KR); Sungku YEO, Suwon-si (KR)

(21) Appl. No.: 19/047,102

(22) Filed: Feb. 6, 2025

Related U.S. Application Data
(63) Continuation of application No. PCT/KR2023/008481, filed on Jun. 19, 2023.

(30) Foreign Application Priority Data
Aug. 18, 2022 (KR) 10-2022-0103633

(51) Int. Cl. H02J 50/12; H02J 50/00; H02J 50/40; H02J 50/80; H02J 50/90; H04B 5/79

(52) U.S. Cl. CPC H02J 50/12; H02J 50/005; H02J 50/40; H02J 50/80; H02J 50/90; H04B 5/79

(57) ABSTRACT

A wireless power transmission apparatus is provided. The wireless power transmission apparatus includes a resonant circuit corresponding to a first frequency, a rectifier circuit configured to rectify first alternating current (AC) power of the first frequency provided from the resonant circuit, at least one conversion circuit configured to convert the rectified power into second AC power of a second frequency, at least one transmission coil connected to the at least one conversion circuit, respectively, at least one switch connected to the resonant circuit, memory storing one or more computer programs, and one or more processors communicatively coupled to the memory, wherein, based on identifying that a first wireless power reception device supporting a first charging scheme based on the first frequency is disposed on at least a portion of at least one charging area of the wireless power transmission device, the one or more computer programs include computer-executable instructions that, when executed by the one or more processors individually or collectively, cause the wireless power transmission device to control the at least one switch such that the resonant circuit forms a closed loop, wherein, based on identifying that a second wireless power reception device supporting a second charging scheme based on the second frequency is disposed on at least a portion of at least one charging area of the wireless power transmission device, the one or more computer programs include computer-executable instructions that, when executed by the one or more processors individually or collectively, cause the wireless power transmission device to control the at least one switch to allow the resonant circuit not to form the closed loop, and control at least some of the at least one conversion circuit to provide the second AC power of the second frequency, wherein the second AC power is provided to at least a portion of the at least one transmission coil.

### CROSS-REFERENCE TO RELATED APPLICATION(S)

This application is a continuation application, claiming priority under § 365 (c), of an International application No. PCT/KR2023/008481, filed on Jun. 19, 2023, which is based on and claims the benefit of a Korean patent application number 10-2022-0103633, filed on Aug. 18, 2022, in the Korean Intellectual Property Office, the disclosure of which is incorporated by reference herein in its entirety.

### BACKGROUND

### 1. Field

The disclosure relates to a wireless power transmission device wirelessly transmitting power and method for operating the same.

### 2. Description of Related Art

Portable digital communication devices have become a must-have item for everyone in modern era. Customers desire to receive various high-quality services anytime, anywhere. Internet of thing (IoT) technology recently bundles various sensors, home appliances, and communication devices up into a single network. A diversity of sensors require a wireless power transmission system for seamless operations. Small Bluetooth headsets, wearing devices, smartphones, or robots, vacuums, or other large-scale electronic devices may be implemented to wirelessly receive power.

Wireless power transmission may be performed in a magnetic induction, magnetic resonance, and electromagnetic wave scheme. The magnetic induction or magnetic resonance scheme is advantageous in charging electronic devices positioned within a relatively short distance from the wireless power transmission device. The electromagnetic wave scheme is more advantageous for remote power transmission that reaches a few meters as compared with the magnetic induction or magnetic resonance scheme. Such electromagnetic wave scheme is primarily intended for remote power transmission and may exactly grasp the location of remote power receivers and deliver power in a most efficient way.

For wireless power transmission, the wireless power reception device may support at least one charging scheme among magnetic induction, magnetic resonance, and electromagnetic wave schemes. To charge wireless power reception devices with various charging schemes, the wireless power transmission device may support multiple charging schemes.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a wireless power transmission device wirelessly transmitting power and method for operating the same.

Additional aspects will be set forth in part in the description which follows and, in part, will be apparent from the description, or may be learned by practice of the presented embodiments.

In accordance with an aspect of the disclosure, a wireless power transmission device is provided. The wireless power transmission device includes a resonance circuit corresponding to a first frequency, a rectification circuit configured to rectify first alternating current (AC) power of the first frequency provided from the resonance circuit, at least one conversion circuit configured to convert the rectified power into second AC power of a second frequency, at least one transmission coil connected to the at least one conversion circuit respectively, at least one switch connected to the resonance circuit, memory storing one or more computer programs, and one or more processors communicatively coupled to the memory, wherein, based on identifying that a first wireless power reception device supporting a first charging scheme based on the first frequency is disposed on at least a portion of at least one charging area of the wireless power transmission device, the one or more computer programs include computer-executable instructions that, when executed by the one or more processors individually or collectively, cause the wireless power transmission device to control the at least one switch to allow the resonance circuit to form a closed loop, wherein, based on identifying that a second wireless power reception device supporting a second charging scheme based on the second frequency is disposed on at least a portion of the at least one charging area of the wireless power transmission device, the one or more computer programs include computer-executable instructions that, when executed by the one or more processors individually or collectively, cause the wireless power transmission device to control the at least one switch to allow the resonance circuit not to form the closed loop, and control at least some of the at least one conversion circuit to provide the second AC power of the second frequency, wherein the second AC power is provided to at least some of the at least one transmission coil.

In accordance with another aspect of the disclosure, a method for operating a wireless power transmission device including a resonance circuit corresponding to the first frequency, a rectification circuit configured to rectify first AC power of the first frequency provided from the resonance circuit, at least one conversion circuit configured to convert the rectified power into second AC power of a second frequency, at least one transmission coil connected to the at least one conversion circuit respectively, and at least one switch connected to the resonance circuit is provided. The method includes, based on identifying that a first wireless power reception device supporting a first charging scheme based on the first frequency is disposed on at least a portion of at least one charging area of the wireless power transmission device, controlling the at least one switch to allow the resonance circuit to form a closed loop, based on identifying that a second wireless power reception device supporting a second charging scheme based on the second frequency is disposed on at least a portion of the at least one charging area of the wireless power transmission device, controlling the at least one switch to allow the resonance circuit not to form the closed loop, and controlling at least some of the at least one conversion circuit to provide the second AC power of the second frequency, wherein the second AC power is provided to at least some of the at least one transmission coil.

In accordance with another aspect of the disclosure, one or more non-transitory computer-readable storage media storing computer-executable instructions that, when executed by one or more processors individually or collectively, cause a wireless power transmission device to perform operations, the wireless power transmission device including a resonance circuit corresponding to a first frequency, a rectification circuit configured to rectify first alternating current (AC) power of the first frequency provided from the resonance circuit, at least one conversion circuit configured to convert the rectified power into second AC power of a second frequency, at least one transmission coil connected to the at least one conversion circuit respectively, and at least one switch connected to the resonance circuit are provided. The operations include based on identifying that a first wireless power reception device supporting a first charging scheme based on the first frequency is disposed on at least a portion of at least one charging area of the wireless power transmission device, controlling the at least one switch to allow the resonance circuit to form a closed loop, based on identifying that a second wireless power reception device supporting a second charging scheme based on the second frequency is disposed on at least a portion of the at least one charging area of the wireless power transmission device, controlling the at least one switch to allow the resonance circuit not to form the closed loop, and controlling at least some of the at least one conversion circuit to provide the second AC power of the second frequency, wherein the second AC power is provided to at least some of the at least one transmission coil.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a wireless power transmission/reception system according to an embodiment of the disclosure;

FIG. 2 is a view illustrating a structure of a wireless power transmission device according to an embodiment of the disclosure;

FIG. 3A is a block diagram illustrating a wireless power transmission device when a resonance circuit forms a closed loop according to an embodiment of the disclosure;

FIG. 3B is a block diagram illustrating a wireless power transmission device when a resonance circuit does not form a closed loop according to an embodiment of the disclosure;

FIG. 4A is a flowchart illustrating an operation method of a wireless power transmitting device according to an embodiment of the disclosure;

FIG. 4B is a flowchart illustrating an operation method of a wireless power transmitting device according to an embodiment of the disclosure;

FIG. 5 is a flowchart illustrating an operation method of a wireless power transmitting device according to an embodiment of the disclosure;

FIG. 6 is a flowchart illustrating an operation method of a wireless power transmitting device according to an embodiment of the disclosure;

FIG. 7 is a flowchart illustrating an operation method of a wireless power transmission device, an external wireless power transmission device, and a first wireless power reception device according to an embodiment of the disclosure;

FIG. 8 is a flowchart illustrating an operation method of a wireless power transmission device, an external wireless power transmission device, and a first wireless power reception device according to an embodiment of the disclosure;

FIG. 9 is a flowchart illustrating an operation method of a wireless power transmission device, an external wireless power transmission device, and a first wireless power reception device according to an embodiment of the disclosure;

FIG. 10 is a block diagram illustrating a wireless power transmission device according to an embodiment of the disclosure;

FIGS. 11A, 11B, and 11C are views illustrating a configuration of at least one switch according to various embodiments of the disclosure;

FIG. 12A is a view illustrating an on/off state of a switch according to an embodiment of the disclosure;

FIG. 12B is a view illustrating an on/off state of a switch according to an embodiment of the disclosure;

FIG. 13 is a flowchart illustrating a method for operating a wireless power transmission device according to an embodiment of the disclosure;

FIG. 14 is a flowchart illustrating a method of operation of a wireless power transmission device according to an embodiment of the disclosure; and

FIG. 15 is a flowchart illustrating a method of operation of a wireless power transmission device according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

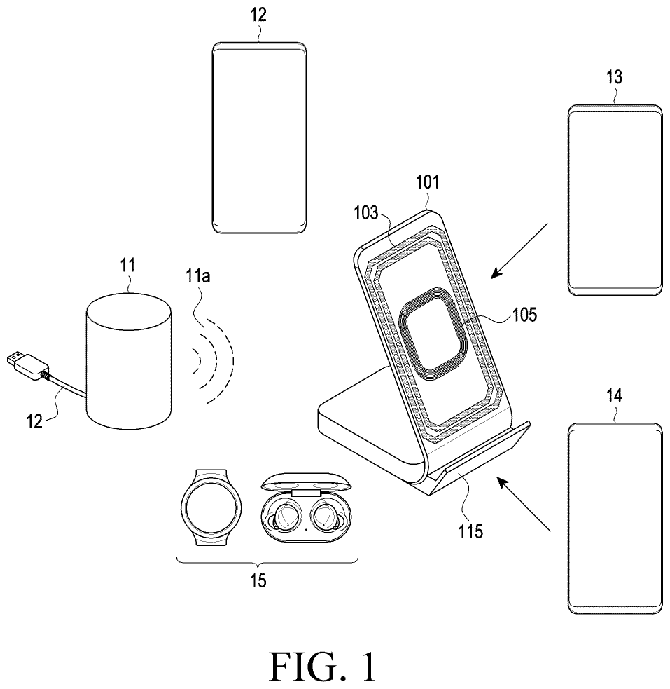

FIG. 1 illustrates a wireless power transmission/reception system according to an embodiment of the disclosure.

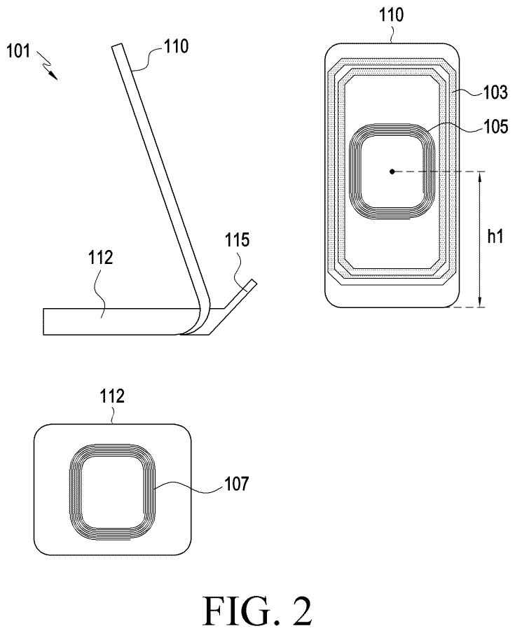

The embodiment of FIG. 1 is described with reference to FIG. 2.

FIG. 2 is a view illustrating a structure of a wireless power transmission device according to an embodiment of the disclosure.

Referring to FIGS. 1 and 2, a wireless power transmission/reception system according to an embodiment may include a wireless power transmission device 101. The wireless power transmission device 101 may wirelessly receive power 11a from, e.g., an external wireless power transmission device 11. For example, an external wireless power transmission device 11 may include a wired power interface 12. The external wireless power transmission device 11 may receive power from an external source through the wired power interface 12. The external wireless power transmission device 11 may wirelessly transmit power 11a using the received power.

According to an embodiment or the disclosure, the external wireless power transmission device 11 may support, e.g., a first charging scheme (e.g., a resonance scheme). Adopting the resonance scheme, the external wireless power transmission device 11 may include, e.g., a power source, a direct current (DC)-AC conversion circuit, an amplification circuit, an impedance matching circuit, at least one capacitor, at least one coil, and an out-band communication circuit (e.g., a Bluetooth low energy (BLE) communication circuit). The at least one capacitor and the at least one coil may constitute a resonance circuit. The external wireless power transmission device 11 may be implemented in a scheme defined in, e.g., the alliance for wireless power (A4WP) standards (or air fuel alliance (AFA) standards). The external wireless power transmission device 11 may include a coil that is capable of produce a magnetic field when letting an electric current (e.g., AC current) flow thereacross by a resonance scheme. The process of generating a magnetic field through the coil by the external wireless power transmission device 11 may be represented as wirelessly transmitting power. Further, as described below, the process of generating a magnetic field through a transmission coil based on a second charging scheme (e.g., an induction scheme) by the wireless power transmission device 101 may be represented as wirelessly transmitting power. For example, the wireless power transmission device 12 supporting the first charging scheme (e.g., a resonance scheme) may receive at least a portion of the power 11a from the external wireless power transmission device 11. Based on the generated magnetic field, an induced electromotive force may be generated at the wireless power reception device 12. The process of generating an induced electromotive force at the wireless power reception device 12 may be represented as wirelessly receiving power by the wireless power reception device 12.

The wireless power transmission device 101 according to an embodiment may wirelessly transmit power based on the second charging scheme (e.g., an induction scheme). As described above, the wireless power transmission device 101 may not include a wired power interface. The wireless power transmission device 101 may perform wireless power transmission based on the second charging scheme using at least a portion of the power 11a wirelessly transmitted by the external wireless power transmission device 11. The wireless power transmission device 101 may include an internal battery or may not include an internal battery according to implementations. When the internal battery is not included, the wireless power transmission device 101 may perform wireless power transmission based on the second charging scheme using at least a portion of the power 11A wirelessly transmitted by the external wireless power transmission device 11. When the internal battery is included, the wireless power transmission device 101 may perform wireless power transmission based on the second charging scheme using at least a portion of the power from the internal battery and/or the power 11A wirelessly transmitted by the external wireless power transmission device 11. The wireless power transmission device 101 may charge the internal battery using at least a portion of the wirelessly transmitted power 11a. Meanwhile, in another embodiment or the disclosure, the wireless power transmission device 101 may include a wired power interface and may receive power through the wired power interface from an external source.

For example, a second wireless power reception device 14 supporting the second charging scheme (e.g., an induction scheme) may be disposed on the first housing 110 of the wireless power transmission device 101. The second housing 111 where an object may be mounted may be connected to the first housing 110. For example, the second wireless power reception device 14 may be mounted by the second housing 111, and thus may be disposed on the first housing 110. A transmission coil 105 for a second charging scheme (e.g., an induction scheme) may be included in the first housing 110. The center point of the transmission coil 105 may be h1 away from, e.g., one end of the first housing 110, which may be set based on, e.g., the position of the reception coil in the second wireless power reception device 14, but is not limited thereto. For example, the second wireless power reception device 14 may be a smartphone, and h1 may be set based on a general position of the reception coil of the smartphone. Alternatively, although not illustrated, the wireless power transmission device 101 may include a plurality of transmission coils for a second charging scheme (e.g., an induction scheme) included in the first housing 110. As the plurality of transmission coils are included in the first housing 110, even when wireless power reception devices of various sizes are mounted on the second housing 111, the wireless power reception devices of various sizes may wirelessly receive power with relatively high efficiency.

For example, a third wireless power reception device 15 supporting the second charging scheme (e.g., the induction scheme) may be disposed on a third housing 112 of the wireless power transmission device 101. One end of the third housing 112 may be connected to, e.g., one end of the first housing 110 as illustrated in FIG. 2, but is not limited thereto. For example, when the wireless power transmission device 101 is disposed on a plane, the third housing 112 may contact the plane. When the third housing 112 contacts the plane, the first housing 110 may be positioned to have an angle of 90 degrees or less with the plane, and accordingly, the second wireless power reception device 14 may be mounted on the second housing 111. The third housing 112 may include a transmission coil 107 for the second charging scheme (e.g., an induction scheme). The position of the transmission coil 107 is not limited. For example, the third wireless power reception device 15 may be a relatively small wearable electronic device, such as a wireless earphone or a wristwatch-type electronic device, but is not limited thereto. Alternatively, although not illustrated, the wireless power transmission device 101 may include a plurality of transmission coils for the second charging scheme (e.g., an induction scheme) included in the third housing 112. As the plurality of transmission coils are included in the third housing 112, even when wireless power reception devices are disposed at various positions, power may be wirelessly received with relatively high efficiency.

For example, the wireless power transmission device 101 may transmit power in an induction scheme. Adopting the induction scheme, the wireless power transmission device 101 may include, e.g., a power source, a direct current (DC)-alternating current (AC) conversion circuit, an amplification circuit, an impedance matching circuit, at least one capacitor, at least one coil, and a communication modulation/demodulation circuit. The at least one capacitor together with the at least one coil may constitute a resonance circuit. The wireless power transmission device 101 may be implemented in a scheme defined in the wireless power consortium (WPC) standards (or Qi standards). The wireless power transmission device 101 may communicate with the wireless power receiving device 14.15. For example, the wireless power transmitting device 101 may communicate with the wireless power receiving device 14.15 according to an in-band scheme. The wireless power transmission device 101 may perform the frequency shift-keying (FSK) based on the data to be transmitted, and thus the wireless power reception device 14 or 15 may identify the data. The wireless power reception device 14 or 15 may perform amplitude-shift keying (ASK) (which may be referred to as, e.g., on/off keying) based on data to be transmitted, and thus the wireless power transmission device 101 may identify data. The wireless power transmission device 101 may identify data by performing demodulation and/or decoding based on, e.g., a change in the magnitude of current, voltage, and/or power applied from the coil 105 or 107. Those skilled in the art will understand that in-band communication based on encoding and/or FSK modulation and/or ASK modulation may be expressed as transmission of a communication signal for convenience of description, and in-band communication based on FSK demodulation and/or ASK demodulation and/or decoding may be expressed as reception of a communication signal for convenience of description. Meanwhile, the wireless power transmission device 101 may perform out-band scheme-based communication with the wireless power reception device 14 or 15.

According to an embodiment or the disclosure, the wireless power transmission device 101 may additionally include a coil (or a conductor having a pattern for detection) for detection of the wireless power reception device of the first charging scheme (e.g., a resonance scheme) included in the first housing 110. The wireless power transmission device 101 may detect a first wireless power reception device 13 of the first charging scheme, based at least on a change in impedance (or load) in the coil 103 and/or the coil for detection. Meanwhile, the wireless power transmission device 101 may detect the first wireless power reception device 13 based on sensing data identified by another sensing means for detection. For example, the wireless power transmission device 101 may detect the first wireless power reception device 13, based on a communication signal (e.g., an out-band signal, but not limited thereto) from the first wireless power reception device 13 and/or the external wireless power transmission device 11. The detection scheme of the first wireless power reception device 13 is not limited, and various detection schemes are described below.

For example, as the electronic device 13 supporting the first charging scheme (e.g., the resonance scheme) is mounted by the second housing 111, it may be disposed on the first housing 110. Based on identifying that the electronic device 13 supporting the first charging scheme is disposed in the first housing 110, the wireless power transmission device 101 may control at least one switch (not shown) so that the resonance circuit of the coil 103 and the capacitor (not shown) forms a closed loop. When the resonance circuit of the coil 103 and the capacitor (not shown) forms a closed loop, the resonance circuit may be designed to have a first charging scheme resonant frequency. When the resonance circuit forms a closed loop, the resonance circuit may be used as a repeater in the first charging scheme. For example, a coil 103 for forming a resonance circuit may be disposed in the first housing 110. Although it has been described that the coil 103 has, e.g., a larger outer diameter than the second coil 105 and/or is disposed outside the second coil 105, this is illustrative and the size, shape, and/or arrangement position of the second coil 105 is not limited. For example, the electronic device 13 supporting the first charging scheme (e.g., the resonance scheme) may receive at least a portion of the power 11a wirelessly transmitted from the external wireless power transmission device 11. Meanwhile, when the distance between the external wireless power transmission device 11 and the first wireless power reception device 13 is relatively large, the wireless power transmission efficiency between the external wireless power transmission device 11 and the first wireless power reception device 13 may be relatively low (in other words, it may be expressed that the coupling coefficient between the external wireless power transmission device 11 and the first wireless power reception device 13 is relatively low). Accordingly, the amount of charge per hour for the first wireless power reception device 13 is relatively small, and thus the time required until the first wireless power reception device 13 is fully charged may increase. Alternatively, the distance for charging the first wireless power reception device 13 with the amount of charge per hour equal to or larger than a predetermined level may be limited. As described above, when there is a resonance circuit of a closed loop operating as a repeater, the wireless power transmission efficiency between the external wireless power transmission device 11 and the first wireless power reception device 13 may be relatively increased (in other words, it may be expressed that the coupling coefficient between the external wireless power transmission device 11 and the first wireless power reception device 13 is relatively increased). Accordingly, the amount of charge per hour for the first wireless power reception device 13 may be relatively increased, and thus the time required until the first wireless power reception device 13 is fully charged may be reduced. Alternatively, the distance for charging the first wireless power reception device 13 with the amount of charge per hour equal to or larger than a predetermined level may be increased.

According to an embodiment or the disclosure, the wireless power transmission device 101 may include an indicator 115. For example, when power having a sufficient magnitude is received by the first charging scheme, the wireless power transmission device 101 may control an indicator 115 to provide an indication corresponding thereto. For example, the wireless power transmission device 101 may control the indicator 115 to provide an indication when the voltage at the output terminal of the coil 103 or the rectified voltage VREC is larger than or equal to a threshold voltage, but is not limited thereto. Accordingly, the user may recognize whether the wireless power transmission device 101 may operate using the power 11a from the external wireless power transmission device 11.

According to an embodiment or the disclosure, the wireless power transmission device 101 may transmit power according to an electromagnetic wave scheme. When the wireless power transmission device 101 uses an electromagnetic wave scheme, the wireless power transmission device 101 may include, e.g., a power source, a DC-AC conversion circuit, an amplification circuit, a distribution circuit, a phase shifter, a power transmission antenna array including a plurality of antennas (e.g., a patch antenna, a dipole antenna, and/or a monopole antenna), an out-band communication circuit (e.g., a BLE communication module), or the like. Each of the plurality of antennas may form a radio frequency (RF) wave. The wireless power transmission device 101 may perform beam-forming by adjusting the phase and/or amplitude of an electrical signal input for each antenna. The electronic device 2 or 3 may include antennas capable of outputting electric current using RF waves generated around. The process of the wireless power transmission device 101 producing RF waves may be represented as the wireless power transmission device 101 wirelessly transmitting power. The process of outputting current from the antenna using the RF wave by the wireless power reception device supporting the RF scheme may be expressed as wirelessly receiving the power by the wireless power reception device=. In the disclosure, it has been described that the wireless power transmission device 101 uses the resonance scheme as the first charging scheme and the induction scheme as the second charging scheme, but any one of the charging schemes may be replaced with the RF scheme.

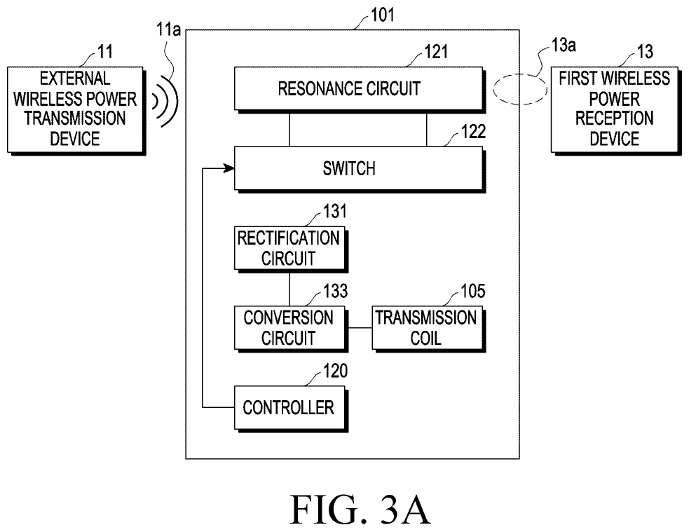

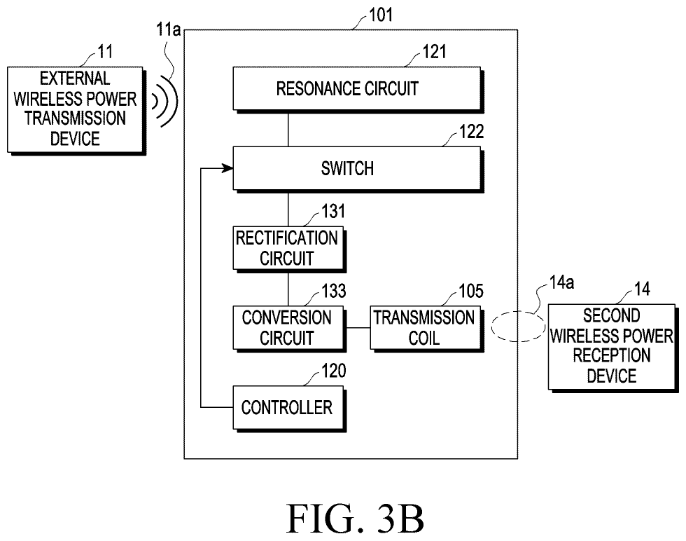

FIG. 3A is a block diagram illustrating a wireless power transmission device when a resonance circuit forms a closed loop according to an embodiment of the disclosure.

FIG. 3B is a block diagram illustrating a wireless power transmission device when a resonance circuit does not form a closed loop according to an embodiment of the disclosure.

Referring to FIG. 3A, according to an embodiment or the disclosure, the wireless power transmission device 101 may include a transmission coil 105, a controller 120, a resonance circuit 121, at least one switch 122, a rectification circuit 131, and/or a conversion circuit 133.

According to an embodiment or the disclosure, the resonance circuit 121 may include the coil 103 and at least one capacitor (not shown) described with reference to FIGS. 1 and 2. The coil 103 and at least one capacitor (not shown) may form the resonance circuit 121, and the resonance frequency of the resonance circuit 121 may be, e.g., a frequency defined in the first charging scheme (e.g., the resonant scheme) (e.g., 6.78 MHz defined in the AFA, but not limited thereto). The resonance circuit 121 (or the coil 103 included in the resonance circuit 121) may form a coupling 13a with the first wireless power reception device 13.

According to an embodiment or the disclosure, the on/off state of at least one switch 122 may be controlled by the controller 120. In the example of FIG. 3A, on/off of each of the at least one switch 122 may be controlled so that the resonance circuit 121 forms a closed loop, and for convenience of description, it may be expressed that the state of the at least one switch 122 is controlled in a first state. Various embodiments in which the state of the at least one switch 122 is controlled in the first state are described below. Referring to FIG. 3A, when the resonance circuit 121 forms a closed loop, the resonance circuit 121 may be used as a repeater for the first charging scheme. For example, the first wireless power reception device 13 may receive at least a portion of the power 11a from the external wireless power transmission device 11. The frequency of the power 11a may have, e.g., a frequency (e.g., 6.78 MHz, but not limited thereto) defined in the first charging scheme. As the resonance circuit 121 forming the closed loop is disposed near the reception coil (or reception resonance coil) of the first wireless power reception device 13, the magnitude of the induced electromotive force at the reception coil (or reception resonance coil) of the first wireless power reception device 13 may increase. Accordingly, the amount of charge per hour for the first wireless power reception device 13 may be relatively increased, and thus the time required until the first wireless power reception device 13 is fully charged may be reduced. Alternatively, the distance for charging the first wireless power reception device 13 with the amount of charge per hour equal to or larger than a predetermined level may be increased. Meanwhile, the first wireless power reception device 13 may be, rather than being disposed on the first housing 110 of the wireless power transmission device 101, disposed a predetermined distance apart from the first housing 110. When the distance between the first wireless power reception device 13 and the external wireless power transmission device 11 is relatively long, wireless power transmission efficiency may be degraded. However, as the repeater is disposed between the first wireless power reception device 13 and the external wireless power transmission device 11, degradation of wireless power transmission efficiency may be compensated.

According to an embodiment or the disclosure, the controller 120 may control at least one switch 122 so that the resonance circuit 121 forms a closed loop, based on identifying detection of the first wireless power reception device 13 supporting the first charging scheme (for example, the first wireless power reception device 13 is disposed on the first housing 110 but is not limited). Various methods in which the controller 120 detects a wireless power reception device supporting the first charging scheme are described below. For example, information about the on/off state of each of the at least one switch 122 corresponding to the detection of the first wireless power reception device 13 may be stored in the wireless power transmission device 101, and the controller 120 may control the state of the at least one switch 122 (e.g., controls in the first state) with reference thereto. The controller 120 may be implemented as a microprocessor, a micro controlling unit (MCU), a field programmable gate array (FPGA), an application specific integrated circuits (ASIC), or a set of analog elements, but is not limited thereto.

According to an embodiment or the disclosure, the controller 120 may include at least one block (which may be referred to as a communication module) for out-band communication (e.g., BLE communication, but not limited thereto) and/or in-band communication. Alternatively, a block for out-band communication and/or a block for in-band communication may be implemented independently from the controller 120 (e.g., it may be implemented as a hardware block different from the controller 120). The controller 120 may transmit/receive a communication signal to/from at least some of the external wireless power transmission device 11 and the wireless power reception devices 13, 14, and 15. For example, the controller 120 may detect at least some of the wireless power reception devices 13, 14, and 15 based on transmission/reception of a communication signal. For example, the controller 120 may perform a pre-charging procedure (which may be, e.g., identification, configuration, authentication, authority identification, cross-connection check, negotiation, calibration, registration, charging determination, charging initiation command, but is not limited) and/or a charging procedure (e.g., charging initiation command) based on transmission/reception of a communication signal, and/or a mid-charging procedure (which is, e.g., reporting, adjustment of charging power, and determination of an error (overtemperature, overvoltage, overcurrent, etc., but is not limited). According to an embodiment or the disclosure, the wireless power transmission device 101 may include memory for storing instructions enabling the wireless power transmission device 101 to perform operations, a stack associated with the first charging scheme, a stack associated with the second charging scheme, and/or a stack for communication. The memory may be implemented to be included in the controller 120, or may be implemented as hardware independent of the controller 120.

Meanwhile, in FIG. 3A, as the at least one switch 122 is controlled in the first state, two solid lines between the resonance circuit 121 and the switch 122 are connected to represent a point where the resonance circuit 121 forms a closed loop, and those skilled in the art will understand that the number of solid lines is not intended to represent a single-ended signal or a differential signal. Further, FIG. 3A illustrates that when the resonance circuit 121 forms a closed loop, there is no electrical connection between the switch 122 and the rectification circuit 131, but this is illustrative, and according to implementation, there may be an electrical connection between the switch 122 and the rectification circuit 131, which is described below.

Referring to FIG. 3B, according to an embodiment or the disclosure, the controller 120 may detect (e.g., detect placement on the first housing 110, but not limited thereto) the second wireless power reception device 14 supporting the second charging scheme. The controller 120 may detect the second wireless power reception device 14 based on whether there is a response corresponding to a digital ping signal, a change in impedance (or load), and/or a change in Q-factor while the ping signal is applied, as a detection scheme based on the second charging scheme (e.g., a detection scheme supported in the Qi standard), but is not limited. Meanwhile, the wireless power transmission device 101 may apply a periodic ping signal to the transmission coil 105 based on a scheme supported in the Qi standard, or may continuously apply power for detection differently from the scheme supported in the Qi standard.

According to an embodiment or the disclosure, the controller 120 may control the at least one switch 122 so that the resonance circuit 121 does not form a closed loop, based on detection of the second wireless power reception device 14 supporting the second charging scheme, which may be expressed as, e.g., controlling the state of the at least one switch 122 in the second state. Meanwhile, when the state of the at least one switch 122 is the second state, the controller 120 may maintain the state of the at least one switch 122 based on detection of the second wireless power reception device 14 supporting the second charging scheme. The controller 120 may control the at least one switch 122 so that power provided from the resonance circuit 121 is provided to the rectification circuit 131. Meanwhile, in FIG. 3B, it will be understood by one of ordinary skill in the art that the resonance circuit 121 and the switch 122 are connected by a single solid line only to express that the resonance circuit 121 does not form a closed loop but is not intended to be a single-ended path.

As the at least one switch 122 is controlled in the second state, power provided from the resonance circuit 121 may be provided to the rectification circuit 131. Since the power provided from the resonance circuit 121 may be induced electromotive force by the external wireless power transmission device 11, it may have a first charging frequency (e.g., 6.78 MHZ, but not limited thereto). The rectification circuit 131 may rectify AC power into DC power. The rectification circuit 131 may be implemented as a full-bridge diode, a half-bridge diode, or a synchronized bridge FET, but is not limited thereto. The conversion circuit 133 may output AC power having a frequency (e.g., 100 to 205 kHz, but not limited thereto) of the second charging scheme using the rectified power. The conversion circuit 133 is not limited as long as it is a component (e.g., an inverter) capable of converting DC power into AC power. The AC power having the frequency of the second charging scheme may be provided to the transmission coil 105. The controller 120 may control the conversion circuit 133 to output AC power for charging. As AC power is applied to the transmission coil 105, power 14a (e.g., a magnetic field) may be wirelessly transmitted, and the second wireless power reception device 14 may wirelessly receive power. As described above, the wireless power transmission device 101 may perform wireless charging of the second wireless power reception device 14 supporting the second charging scheme using at least a portion of the power 11a received based on the first charging scheme.

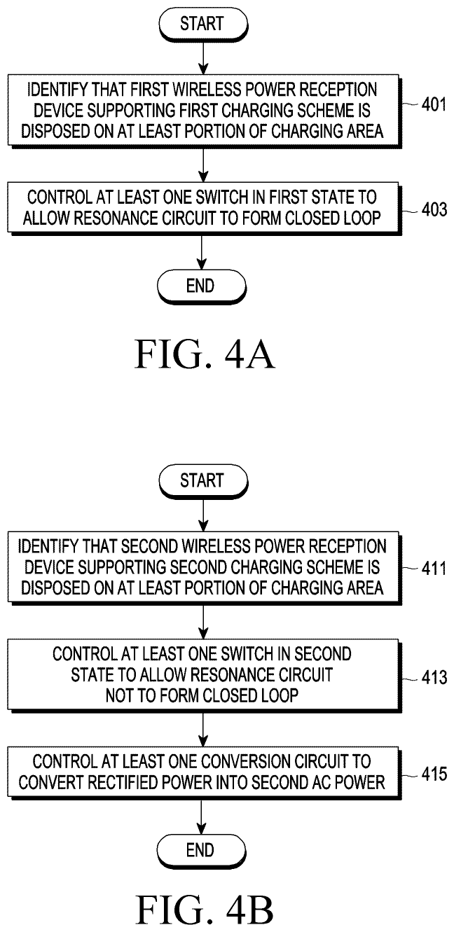

FIG. 4A is a flowchart illustrating an operation method of a wireless power transmitting device according to an embodiment of the disclosure.

Referring to FIG. 4A, in operation 401, the wireless power transmission device 101 (e.g., the controller 120) may identify that the first wireless power reception device 13 supporting the first charging scheme (e.g., the resonance scheme) is disposed on at least a portion of the charging area. For example, the wireless power transmission device 101 may receive a communication signal indicating that the first wireless power reception device 13 is detected from the external wireless power transmission device 11 through, e.g., out-band communication. The wireless power transmission device 101 may identify the placement of the first wireless power reception device 130 based on the received communication signal. For example, the wireless power transmission device 101 may identify the placement of the first wireless power reception device 13, based on reception of the communication signal indicating that the first wireless power reception device 13 is detected and satisfaction of at least one additional condition. For example, as the additional condition, the wireless power transmission device 101 may identify whether a change in impedance (or load) for the coil 103 is larger than or equal to a threshold value, and may identify the placement of the first wireless power reception device 13 based on satisfaction of the additional condition, but this is merely an example, and the additional condition is not limited thereto. For example, the wireless power transmission device 101 may identify the placement of the first wireless power reception device 13 without transmission/reception a communication signal with the external wireless power transmission device 11. The wireless power transmission device 101 may identify the placement of the first wireless power reception device 13, e.g., based on transmission/reception of the communication signal with the first wireless power reception device 13. The wireless power transmission device 101 may identify the placement of the first wireless power reception device 13, based on transmission/reception of the communication signal with the first wireless power reception device 13 and satisfaction of at least one additional condition. For example, as the additional condition, the wireless power transmission device 101 may identify whether a change in impedance (or load) for the coil 103 is larger than or equal to a threshold value, and may identify the placement of the first wireless power reception device 13 based on satisfaction of the additional condition, but this is merely an example, and the additional condition is not limited thereto.

According to an embodiment or the disclosure, the wireless power transmission device 101 (e.g., the controller 120) may control the at least one switch 122 in the first state so that the resonance circuit 121 forms a closed loop in operation 403, based on the first wireless power reception device 13 supporting the first charging scheme (e.g., the resonance scheme) being disposed on at least a portion of the charging area. For example, the wireless power transmission device 101 may identify that the first wireless power reception device 13 is disposed while the state of the at least one switch 122 is the second state. If the state of the at least one switch 122 is the second state, the wireless power transmission device 101 may control to provide at least one switch control signal so that the state of the at least one switch 122 is switched from the second state to the first state. For example, the wireless power transmission device 101 may identify that the first wireless power reception device 13 is disposed while the state of the at least one switch 122 is the first state. If the state of the at least one switch 122 is the first state, the wireless power transmission device 101 may control to maintain the state of the at least one switch 122 as the first state.

FIG. 4B is a flowchart illustrating an operation method of a wireless power transmitting device according to an embodiment of the disclosure.

Referring to FIG. 4A, in operation 411, the wireless power transmission device 101 (e.g., the controller 120) may identify that the second wireless power reception device 14 supporting the second charging scheme (e.g., the induction scheme) is disposed on at least a portion of the charging area. For example, the wireless power transmission device 101 may detect the second wireless power reception device 14 based on whether there is a response corresponding to a digital ping signal, a change in impedance (or load), and/or a change in Q-factor while the ping signal is applied, as a detection scheme based on the second charging scheme (e.g., a detection scheme supported in the Qi standard), but is not limited. Meanwhile, the wireless power transmission device 101 may apply a periodic ping signal to the transmission coil 105 based on a scheme supported in the Qi standard, or may continuously apply power for detection differently from the scheme supported in the Qi standard.

According to an embodiment or the disclosure, the wireless power transmission device 101 (e.g., the controller 120) may control the at least one switch 122 to be in the second state so that the resonance circuit 121 does not form a closed loop in operation 413, based on the second wireless power reception device 14 supporting the second charging scheme (e.g., the induction scheme) being disposed on at least a portion of the charging area. For example, the wireless power transmission device 101 may identify that the second wireless power reception device 14 is disposed while the state of the at least one switch 122 is the second state. If the state of the at least one switch 122 is the second state, the wireless power transmission device 101 may control to maintain the state of the at least one switch 122. For example, the wireless power transmission device 101 may identify that the second wireless power reception device 14 is disposed while the state of the at least one switch 122 is the first state. If the state of the at least one switch 122 is the first state, the wireless power transmission device 101 may control to provide at least one switch control signal so that the state of the at least one switch 122 is switched from the first state to the second state. In operation 415, the wireless power transmission device 101 may control the at least one conversion circuit 133 to convert the rectified power into the second AC power for charging. Accordingly, the conversion circuit 133 may convert the rectified power into the second AC power, and the second AC power may be provided to the transmission coil 105. Accordingly, the wireless power transmission device 101 may charge the second wireless power reception device 14 supporting the second charging scheme.

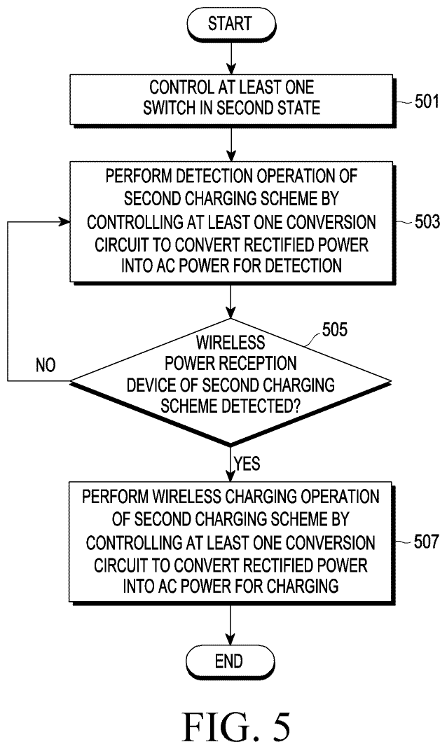

FIG. 5 is a flowchart illustrating an operation method of a wireless power transmitting device according to an embodiment of the disclosure.

Referring to FIG. 5, the wireless power transmission device 101 (e.g., the controller 120) may control the at least one switch 122 in the second state in operation 501. In operation 503, the wireless power transmission device 101 may perform a second charging scheme detection operation by controlling the at least one conversion circuit 133 to convert the rectified power into AC power for detection. The transmission coil 105 may be provided with AC power for detection. The operation of detecting the second charging scheme may include, e.g., an operation of identifying a change in Q-factor while a ping signal is applied, an operation of identifying a change in impedance (or load), and/or an operation of identifying whether there is a response corresponding to a digital ping signal, but is not limited. In operation 505, the wireless power transmission device 101 may identify whether the wireless power reception device of the second charging scheme is detected. For example, the wireless power transmission device 101 may control the conversion circuit 133 to transmit a communication signal corresponding to a digital ping, based on a change in Q-factor by a first threshold value or more and/or a change in impedance (or load) by a second threshold value or more. For example, the conversion circuit 133 may be controlled so that the FSK may be performed to represent data corresponding to the digital ping, but is not limited thereto. The wireless power transmission device 101 may identify whether there is a response thereto from the wireless power reception device. For example, the wireless power transmission device 101 may identify whether there is a response from the wireless power reception device, based on demodulation and/or decoding of the voltage applied to the transmission coil 105. Based on the identification of the response from the wireless power reception device, the wireless power transmission device 101 may identify the placement of the wireless power reception device of the second charging scheme. When the wireless power reception device of the second charging scheme is detected (Yes in 505), the wireless power transmission device 101 may perform the wireless charging operation of the second charging scheme by controlling at least one conversion circuit 133 to convert the rectified power into AC power for charging in operation 507. The transmission coil 105 may be provided with AC power for charging. Meanwhile, the wireless power transmission device 101 may perform a wireless charging operation of the second charging scheme based on performing, e.g., an identification procedure, a configuration procedure, a negotiation procedure, and/or a calibration procedure, but is not limited thereto.

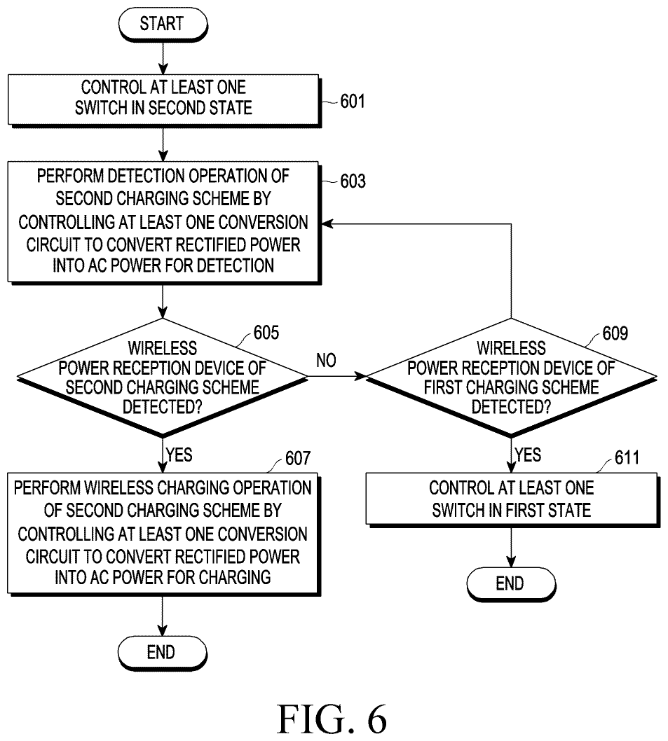

FIG. 6 is a flowchart illustrating an operation method of a wireless power transmitting device according to an embodiment of the disclosure.

Referring to FIG. 6, the wireless power transmission device 101 (e.g., the controller 120) may control the at least one switch 122 in the second state in operation 601. In operation 603, the wireless power transmission device 101 may perform a second charging scheme detection operation by controlling the at least one conversion circuit 133 to convert the rectified power into AC power for detection. In operation 605, the wireless power transmission device 101 may identify whether the wireless power reception device of the second charging scheme is detected. When the wireless power reception device of the second charging scheme is detected (Yes in 607), the wireless power transmission device 101 may perform the wireless charging operation of the second charging scheme by controlling at least one conversion circuit 133 to convert the rectified power into AC power for charging in operation 607. When the wireless power reception device of the second charging scheme is not detected (No in 607), the wireless power transmission device 101 may identify whether the wireless power reception device of the first charging scheme is detected in operation 609. As described above, the wireless power transmission device 101 may identify whether the wireless power reception device of the first charging scheme is detected, based on a communication signal from the external wireless power transmission device 11 and/or an additional condition. For example, the wireless power transmission device 101 may identify whether the wireless power reception device of the first charging scheme is detected, based on a communication signal from the wireless power reception device of the first charging scheme and/or an additional condition. When the wireless power reception device of the first charging scheme is detected (609—Yes), the wireless power transmission device 101 may control the at least one switch 122 in the first state in operation 611. Accordingly, the resonance circuit 121 may form a closed loop, and the resonance circuit 121 may be used as a repeater of the first charging scheme.

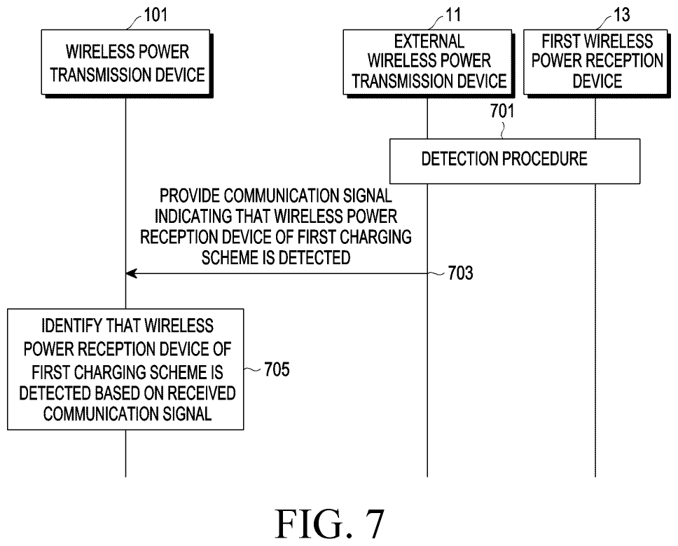

FIG. 7 is a flowchart illustrating an operation method of a wireless power transmission device, an external wireless power transmission device, and a first wireless power reception device according to an embodiment of the disclosure.

Referring to FIG. 7, an external wireless power transmission device 11 may perform a detection procedure with the first wireless power reception device 13 in operation 701. In one example, the external wireless power transmission device 11 may transmit/receive at least one communication signal to/from the first wireless power reception device 13 as an example of the detection procedure. The external wireless power transmission device 11 may identify that the first wireless power reception device 12 is positioned near the external wireless power transmission device 11, based on a communication signal (e.g., an advertisement signal, but not limited thereto) from the first wireless power reception device 13. For example, the external wireless power transmission device 11 may transmit a communication signal (e.g., a connection request corresponding to the advertisement signal, but not limited thereto) to the first wireless power reception device 13. The first wireless power reception device 13 may identify the external wireless power transmission device 11 based on the received communication signal. A communication connection (e.g., BLE connection, but not limited thereto) may be established based on transmission/reception of communication signals. The external wireless power transmission device 11 and the first wireless power reception device 13 may exchange their respective pieces of information (e.g., PRU static information and/or PTU static information, but not limited thereto) based on transmission/reception of additional communication signals through the communication connection. For example, the external wireless power transmission device 11 may determine whether the first wireless power reception device 13 registers with a power network.

According to an embodiment or the disclosure, in operation 703, the external wireless power transmission device 11 may provide a communication signal indicating that the wireless power reception device of the first charging scheme is detected to the wireless power transmission device 101. As described above, the wireless power transmission device 101 may receive a communication signal from the external wireless power transmission device 11 through a communication block included in the controller 120 (which is a communication block independent from the controller 120 and, in this case, may be referred to as a communication module). In operation 705, the wireless power transmission device 101 may identify that the wireless power reception device of the first charging scheme is detected, based on the received communication signal. The wireless power transmission device 101 may identify that the external wireless power transmission device 11 detects the wireless power reception device of the first charging scheme, based on the information included in the received communication signal. In one example, the wireless power transmission device 101 may identify that the wireless power reception device of the first charging scheme is detected based only on information included in the communication signal. In another example, the wireless power transmission device 101 may identify that the wireless power reception device of the first charging scheme is detected, based on reception of the communication signal from the external wireless power transmission device 11 and satisfaction of at least one additional condition. For example, the wireless power transmission device 101 may identify whether the additional condition is met based on whether the change in the impedance (or load) for the coil 103 is larger than or equal to a threshold value. For example, when the communication signal indicating that the wireless power reception device of the first charging scheme is detected is received from the external wireless power transmission device 11, and when a change in impedance (or load) for the coil 103 is larger than or equal to the threshold value, the wireless power transmission device 101 may identify that the wireless power reception device of the first charging scheme is detected. For example, even when the communication signal indicating that the wireless power reception device of the first charging scheme is detected is received from the external wireless power transmission device 11, when the change in impedance (or load) for the coil 103 is less than the threshold value, the wireless power transmission device 101 may identify that the wireless power reception device of the first charging scheme is not detected, but is not limited thereto. As described above, the wireless power transmission device 101 may control the state of the at least one switch 122 in the first state based on detection of the wireless power reception device of the first charging scheme, so that the resonance circuit 121 forms a closed loop to be used as a repeater.

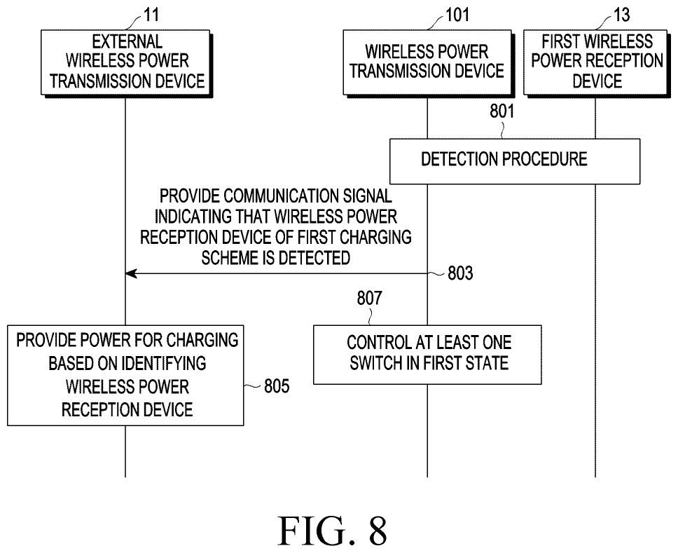

FIG. 8 is a flowchart illustrating an operation method of a wireless power transmission device, an external wireless power transmission device, and a first wireless power reception device according to an embodiment of the disclosure.

Referring to FIG. 8, the wireless power transmission device 101 may perform a detection procedure with the first wireless power reception device 13 in operation 801. In one example, the wireless power transmission device 101 may transmit/receive at least one communication signal to/from the first wireless power reception device 13 as an example of the detection procedure. The wireless power transmission device 101 may identify that the first wireless power reception device 12 is positioned near the wireless power transmission device 101, based on a communication signal (e.g., an advertisement signal, but not limited thereto) from the first wireless power reception device 13. For example, the wireless power transmission device 101 may transmit a communication signal (e.g., a connection request corresponding to the advertisement signal, but not limited thereto) to the first wireless power reception device 13. The first wireless power reception device 13 may identify the wireless power transmission device 101 based on the received communication signal. A communication connection (e.g., BLE connection, but not limited thereto) may be established based on transmission/reception of communication signals. The wireless power transmission device 101 may identify that the wireless power reception device of the first charging scheme is detected, based on, e.g., satisfaction of at least one additional condition. For example, the wireless power transmission device 101 may identify whether the additional condition is met based on whether the change in the impedance (or load) for the coil 103 is larger than or equal to a threshold value. For example, when the communication signal indicating that the wireless power reception device of the first charging scheme is detected is received from the external wireless power transmission device 11, and when a change in impedance (or load) for the coil 103 is larger than or equal to the threshold value, the wireless power transmission device 101 may identify that the wireless power reception device of the first charging scheme is detected. The additional condition may include, e.g., a condition defined in the AFA standard, but is not limited. Additional conditions may include, but are not limited to, those defined in the AFA standard. The wireless power transmission device 101 and the first wireless power reception device 13 may exchange their respective pieces of information (e.g., PRU static information and/or PTU static information, but not limited thereto) based on transmission/reception of additional communication signals through the communication connection. For example, the wireless power transmission device 101 may determine whether the first wireless power reception device 13 registers with a power network.

According to an embodiment or the disclosure, in operation 803, the wireless power transmission device 101 may provide a communication signal indicating that the wireless power reception device of the first charging scheme is detected to the external wireless power transmission device 11. As described above, the wireless power transmission device 101 may transmit a communication signal to the external wireless power transmission device 11 through a communication block included in the controller 120 (which is a communication block independent from the controller 120 and, in this case, may be referred to as a communication module). In operation 805, the external wireless power transmission device 11 may identify that the wireless power reception device of the first charging scheme is detected, based on the received communication signal. The communication signal may include, e.g., information indicating that the wireless power reception device of the first charging scheme is detected, but this is merely an example, and the communication signal may include information requesting to provide charging power. The external wireless power transmission device 11 may wirelessly transmit power for charging. For example, the external wireless power transmission device 11 may increase the magnitude of transmission power, but is not limited thereto. In operation 807, the wireless power transmission device 101 may control the state of the at least one switch 122 in the first state. The resonance circuit 121 may be used as a repeater by forming a closed loop.

Although not illustrated, the wireless power transmission device 101 may transmit, to the external wireless power transmission device 11, a communication signal for requesting to adjust (e.g., increase or decrease) power for charging after charging. For example, the wireless power transmission device 101 may receive a communication signal for reporting a current state (e.g., VREC, but not limited thereto) from the first wireless power reception device 13 performing charging. The wireless power transmission device 101 may determine whether to adjust power for charging, based on the current state information. If the VREC of the first wireless power reception device 13 is less than a designated voltage value, the wireless power transmission device 101 may identify that an increase in charging power is required. In this case, the wireless power transmission device 101 may transmit a communication signal requesting to increase charging power to the external wireless power transmission device 11. The external wireless power transmission device 11 may adjust power for charging based on the received communication signal.

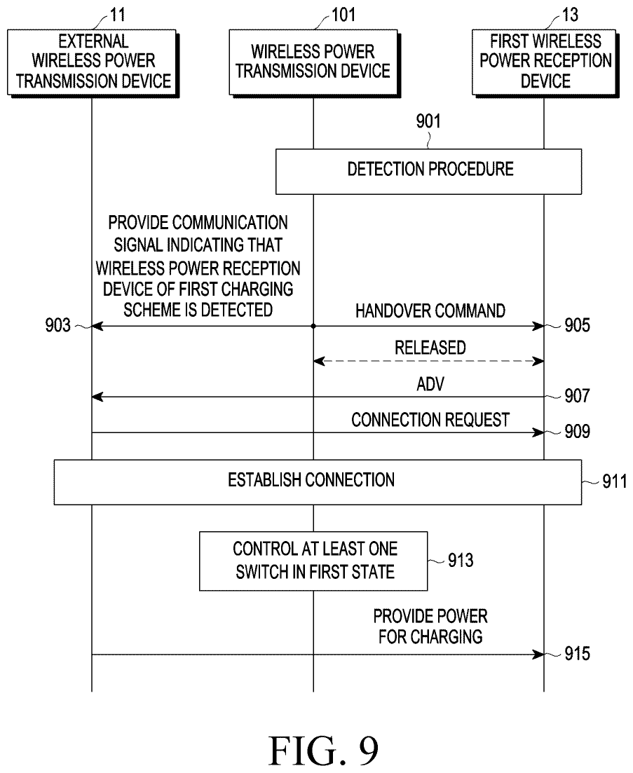

FIG. 9 is a flowchart illustrating an operation method of a wireless power transmission device, an external wireless power transmission device, and a first wireless power reception device according to an embodiment of the disclosure.

Referring to FIG. 9, the wireless power transmission device 101 may perform a detection procedure with the first wireless power reception device 13 in operation 901. The detection procedure of the wireless power transmission device 101 and the first wireless power reception device 13 has been described above with reference to FIG. 8, and thus the description thereof is not repeated. In operation 903, the wireless power transmission device 101 may provide a communication signal indicating that the wireless power reception device of the first charging scheme is detected to the external wireless power transmission device 11. In operation 905, the wireless power transmission device 101 may provide a handover command to the first wireless power reception device 13. Thereafter, the connection (e.g., BLE connection) between the wireless power transmission device 101 and the first wireless power reception device 13 may be released.

According to an embodiment or the disclosure, the first wireless power reception device 13 may transmit the advertisement signal to the external wireless power transmission device 11 in operation 907. Based on reception of the advertisement signal, the external wireless power transmission device 11 may provide a connection request corresponding thereto to the first wireless power reception device 13 in operation 909. Accordingly, in operation 911, a communication connection (e.g., a BLE connection, but not limited thereto) between the external wireless power transmission device 11 and the first wireless power reception device 13 may be established. In operation 913, the wireless power transmission device 101 may control the at least one switch 212 in the first state. For example, the wireless power transmission device 101 may be used as a repeater after handing over the first wireless power reception device 13. In operation 915, the external wireless power transmission device 11 may provide power for charging. Although not shown, the external wireless power transmission device 11 may receive a communication signal for reporting the current state (e.g., VREC but not limited) from the first wireless power reception device 13. The external wireless power transmission device 11 may determine whether to adjust power for charging, based on the current state information. If the VREC of the first wireless power reception device 13 is less than a designated voltage value, the external wireless power transmission device 11 may identify that an increase in charging power is required. In this case, the external wireless power transmission device 11 may increase the charging power. As described above, detection of the first wireless power reception device 13 of the first charging scheme may be performed by the wireless power transmission device 101 and the first wireless power reception device 13, and subsequent procedures may be performed by the external wireless power transmission device 11 and the wireless power reception device 13.

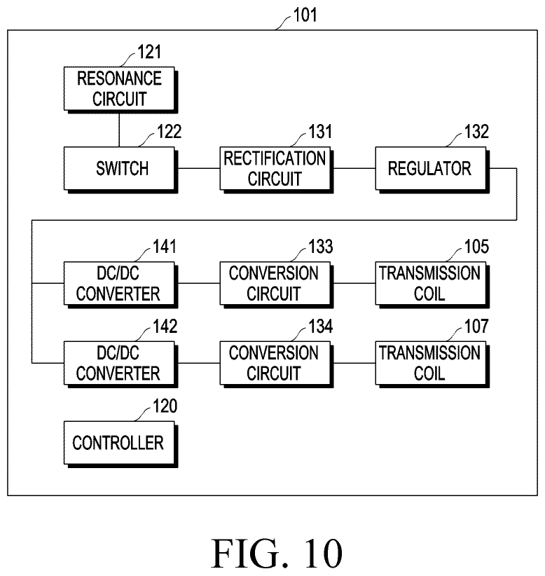

FIG. 10 is a block diagram illustrating a wireless power transmission device according to an embodiment of the disclosure.

Referring to FIG. 10, the wireless power transmission device 101 may include a resonance circuit 121, at least one switch 122, a rectification circuit 131, a regulator 132, at least one DC/DC converter 141 or 142, at least one conversion circuit 133 or 134, and/or at least one transmission coil 105 or 107.

As described above, when the state of the at least one switch 122 is controlled in the first state, the resonance circuit 121 may form a closed loop. When the state of the at least one switch 122 is controlled in the second state, the resonance circuit 121 may not form a closed loop. When the state of the at least one switch 122 is controlled in the second state, AC power of a frequency (e.g., 6.78 MHz, but not limited thereto) of the first charging scheme output from the resonance circuit 121 may be provided to the rectification circuit 131. The rectification circuit 131 may rectify the provided AC power to provide DC power. The regulator 132 may regulate the provided DC power to provide the regulated power. The regulated power may be provided to at least one DC/DC converter 141 or 142. Although not shown, at least one matching network may be connected to at least one point.

According to an embodiment or the disclosure, the at least one DC/DC converter 141 or 142 may convert and provide the voltage of DC power. For example, when a wireless power reception device, such as a smartphone is configured to be charged by the transmission coil 105, the DC/DC converter 141 may be configured to perform conversion to a voltage for charging the wireless power reception device, such as a smartphone, but is not limited thereto. For example, when a small wearable electronic device, such as a wireless earphone is configured to be charged by the transmission coil 107, the DC/DC converter 142 may be configured to perform conversion to the voltage for charging the small wearable electronic device, but is not limited thereto. The DC/DC converter 141 or 142 may adjust the output voltage under the control of the controller 120, but is not limited thereto. The at least one conversion circuit 133 or 134 may provide AC power using the received DC power. For example, the at least one conversion circuit 133 or 134 may adjust the frequency of the AC power under the control of the controller 120. For example, when the second wireless power reception device 14 is charged through the transmission coil 105, the controller 120 may adjust the frequency of the AC power by controlling the conversion circuit 133. Meanwhile, the wireless power reception device may be disposed on any one of the transmission coil 105 or 107, e.g., on the transmission coil 105. In this case, the controller 120 may control the DC/DC converter and/or the conversion circuit 133 to provide power for charging to the transmission coil 105. The controller 120 may control the DC/DC converter 142 and/or the conversion circuit 134 to perform the detection procedure, or may control the DC/DC converter 142 and/or the conversion circuit 134 not to operate.

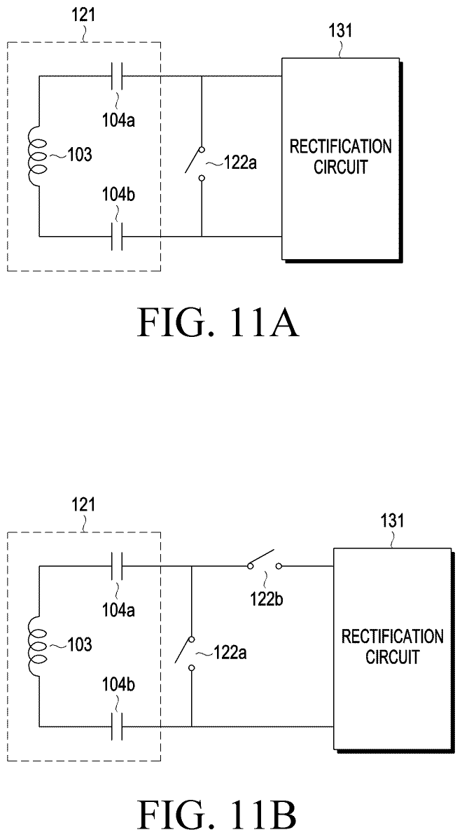

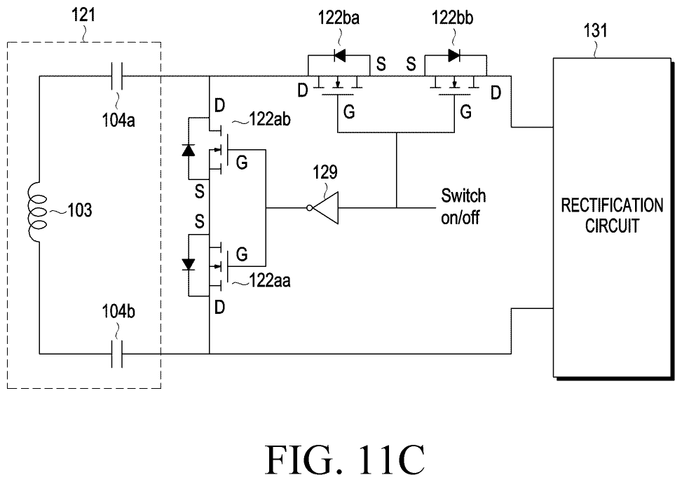

FIGS. 11A, 11B, and 11C are views illustrating a configuration of at least one switch according to various embodiments of the disclosure.

Referring to FIG. 11A, the resonance circuit 121 may include a coil 103 and at least one capacitor 104a and 104b. Although the at least one capacitor 104a or 104b is illustrated as being connected in series with the coil 103, this is merely an example, and it will be understood by one of ordinary skill in the art that the at least one capacitor may be connected in parallel with the coil 103. The wireless power transmission device 101 may include a first switch 122a connected in parallel to the coil 103 of the resonance circuit 121. The first switch 122a may be connected between, e.g., the resonance circuit 121 and the rectification circuit 131. When the first switch 122a is controlled to be turned on, the coil 103 and the at least one capacitor 104a or 104b may form a closed loop. In the embodiment of FIG. 11A, the on state of the first switch 122a may be the first state of the at least one switch 122 described above. While the first switch 122a is controlled in the on state, the coil 103 and the at least one capacitor 104a or 104b forming the closed loop may be used as a repeater in the first charging scheme. Meanwhile, when the first switch 122a is controlled in the off state, the coil 103 and the at least one capacitor 104a or 104b may not form a closed loop. For example, in the embodiment of FIG. 11A, the off state of the first switch 122a may be the second state of the at least one switch 122 described above. The first switch 122a may be implemented as, e.g., an FET, or may be implemented as bidirectional FETs in some cases.

Meanwhile, even while the first switch 122a is controlled in the on state, part of the induced electromotive force may be provided to the rectification circuit 133. For example, the ratio of the power provided from the resonance circuit 121 forming the closed loop to the power provided to the rectification circuit 133 may be ½ to 1/10, but is not limited thereto. Accordingly, even while the resonance circuit 121 forms a closed loop, rectified power from the rectification circuit 133 may be provided, and thus components (e.g., the conversion circuit 133) for the second charging scheme may be operated. The wireless power transmission device 101 according to an embodiment may perform a detection operation of the wireless power reception device of the second charging scheme while controlling the first switch 122a to operate as a repeater according to detection of the wireless power reception device of the first charging scheme. For example, the wireless power transmission device 101 may control the conversion circuit 133 and a communication circuit (not shown) for in-band communication to perform a detection operation. If the wireless power reception device of the second charging scheme is detected, the wireless power transmission device 101 may select and charge either the wireless power reception device of the first charging scheme or the wireless power reception device of the second charging scheme, or may charge both the devices substantially simultaneously.

Referring to FIG. 11B, the wireless power transmission device 101 according to an embodiment may include a first switch 122a connected in parallel to the coil 103 and a second switch 122b connected between the first switch 122a and the rectification circuit 131. For example, when the wireless power transmission device 101 of the first charging scheme is detected, the wireless power transmission device 101 may control the first switch 122a in the on state so that the coil 103 and the at least one capacitor 104a or 104b form a closed loop. Further, the wireless power transmission device 101 may control the second switch 122b in the off state, thereby preventing the resonance circuit 121 from being electrically connected to the rectification circuit 131. For example, even when the first switch 122a is controlled in the on state and the second switch 122b is also controlled in the on state, some induced electromotive force may be provided to the rectification circuit 131. Accordingly, as the second switch 122b is controlled in the off state, the amount of charge per hour of the wireless power reception device of the first charging scheme may be increased. For example, the wireless power transmission device 101 may control the first switch 122a in the on state and the second switch 122b in the off state in order to charge the wireless power reception device of the first charging scheme relatively quickly. In the embodiment of FIG. 11B, the on state of the first switch 122a and the off state of the second switch 122b may be the first state of the at least one switch 122 described above. For example, in order to charge the wireless power reception device of the first charging scheme relatively quickly, the first state of the at least one switch 122 described above may be maintained. If the wireless power reception device of the first charging scheme and the wireless power reception device of the second charging scheme are simultaneously charged, or if it is determined whether the wireless power reception device of the second charging scheme is detected while the wireless power reception device of the first charging scheme is charged, the wireless power transmission device 101 may control the first switch 122a in the on state and the second switch 122b in the on state. For example, when the wireless power reception device of the first charging scheme is disposed in the first housing 110 of FIG. 2 and the wireless power reception device of the second charging scheme is disposed in the third housing 112, simultaneous charging may be possible. Alternatively, if the wireless power reception device of the first charging scheme and the wireless power reception device of the second charging scheme are simultaneously charged, or if it is determined whether the wireless power reception device of the second charging scheme is detected while the wireless power reception device of the first charging scheme is charged, the wireless power transmission device 101 may control the first switch 122a in the off state and the second switch 122b in the on state. Meanwhile, when the wireless power reception device of the second charging scheme is detected, the wireless power transmission device 101 may control the first switch 122a in the off state and may control the second switch 122b in the on state. In the embodiment of FIG. 11B, the off state of the first switch 122a and the on state of the second switch 122b may be the second state of the at least one switch 122.

Referring to FIG. 11C, according to an embodiment or the disclosure, the wireless power transmission device 101 may include a first sub switch 122aa and a second sub switch 122ab connected in parallel to the coil 103. The first sub switch 122aa and the second sub switch 122ab are FETs and may be connected in opposite directions. The wireless power transmission device 101 may include a third sub switch 122ba and a fourth sub switch 122bb connected between the sub switches 122aa and 122ab and the rectification circuit 131. The third sub switch 122ba and the fourth sub switch 122bb are FETs and may be connected in opposite directions. For example, when the wireless power transmission device 101 detects the wireless power reception device of the first charging scheme, the wireless power transmission device 101 may control the first sub switch 122aa and the second sub switch 122ab in the on state so that the coil 103 and the at least one capacitor 104a or 104b form a closed loop. In this case, e.g., the wireless power transmission device 101 may control the third sub switch 122ba and the fourth sub switch 122bb in the off state. For example, when the wireless power transmission device 101 detects the wireless power reception device of the second charging scheme, the wireless power transmission device 101 may control the third sub switch 122ba and the fourth sub switch 122bb in the on state so that the coil 103 and the at least one capacitor 104a or 104b do not form a closed loop. In this case, e.g., the wireless power transmission device 101 may control the first sub switch 122aa and the second sub switch 122ab in the off state. For example, the wireless power transmission device 101 may provide a switch control signal (Switch on/off) to the third sub switch 122ba and the fourth sub switch 122bb. The wireless power transmission device 101 may include an inverting element 129 connected to the first sub switch 122aa and the second sub switch 122ab. The switch control signal (Switch on/off) may be inverted by the inverting element 129 and provided to the first sub switch 122aa and the second sub switch 122ab. Accordingly, the states of the first sub switch 122aa and the second sub switch 122ab may be controlled to be opposite to the states of the third sub switch 122ba and the fourth sub switch 122bb.

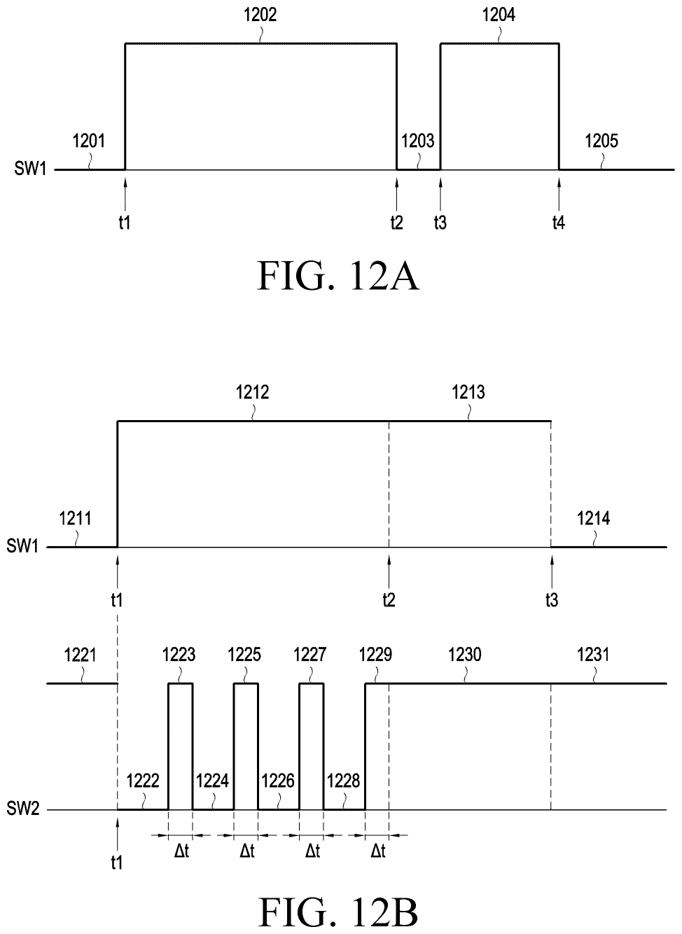

FIG. 12A is a view illustrating an on/off state of a switch according to an embodiment of the disclosure.

Referring to FIG. 12A, the wireless power transmission device 101 may include a first switch 122a connected in parallel to the coil 103 as shown in FIG. 11A. For example, the wireless power transmission device 101 may control the first switch 122a in the off state 1201 in the default state (e.g., before a first time point t1), but is not limited thereto. In the off state 1201 of the first switch 122a, the wireless power transmission device 101 may identify whether the wireless power reception device of the first charging scheme is detected and/or whether the wireless power reception device of the second charging scheme is detected. While the first switch 122a is in the off state 1201, power rectified from the rectification circuit 131 may be provided, and accordingly, a component for the second charging scheme may be operated. The wireless power transmission device 101 may identify whether the wireless power reception device of the second charging scheme is detected by operating the component for the second charging scheme.

According to an embodiment or the disclosure, it is assumed that the wireless power reception device of the first charging scheme is detected at the first time point t1. At a first time point t1, the wireless power transmission device 101 may control the first switch 122a in the on state 1202 so that the resonance circuit 121 forms a closed loop, based on detection of the wireless power reception device of the first charging scheme. As the resonance circuit 121 forms a closed loop, the resonance circuit 121 may be used as a repeater.

Meanwhile, at the second time point t2, the wireless power transmission device 101 may identify the recovery (or removal) of the wireless power reception device of the first charging scheme, full charge of the wireless power reception device of the first charging scheme, and/or an occurrence of an error of the wireless power reception device of the first charging scheme. The wireless power transmission device 101 may identify the above-described charging stop events based on transmission/reception of a communication signal with the wireless power reception device of the first charging scheme and/or the external wireless power transmission device 11, but the identification scheme is not limited thereto. Based on the charging stop event, the wireless power transmission device 101 may control the first switch 122a in the off state 1203. The resonance circuit 121 may not form a closed loop.

According to an embodiment or the disclosure, it is assumed that the wireless power reception device of the first charging scheme is detected at the third time point t3. At the third time point t3, the wireless power transmission device 101 may control the first switch 122a in the on state 1204 so that the resonance circuit 121 forms a closed loop, based on detection of the wireless power reception device of the first charging scheme. As the resonance circuit 121 forms a closed loop, the resonance circuit 121 may be used as a repeater.

Meanwhile, at the fourth time point t4, it is assumed that the wireless power transmission device 101 detects the wireless power reception device of the second charging scheme. As described above, even while the first switch 122a is maintained in the on state, a portion of the induced electromotive force may be provided to the rectification circuit 131, and accordingly, a component of the second charging scheme may be operated. The wireless power transmission device 101 may determine whether the wireless power reception device of the second charging scheme is detected using the component of the second charging scheme, and for example, it is assumed that the wireless power reception device of the second charging scheme is detected at the fourth time point t4. The wireless power transmission device 101 may identify to charge, e.g., the wireless power reception device of the second charging scheme, or may identify to put the second charging scheme in a higher priority. In this case, the wireless power transmission device 101 may control the first switch 122a in the off state 1205. Meanwhile, if it is identified that the wireless power transmission device 101 simultaneously charges, e.g., the wireless power reception device of the first charging scheme and the wireless power reception device of the second charging scheme, the on state 1204 of the first switch 122a may be maintained, but is not limited thereto.

FIG. 12B is a view illustrating an on/off state of a switch according to an embodiment of the disclosure.

Referring to FIG. 12B, the wireless power transmission device 101 may include a first switch 122a and a second switch 122b as shown in FIG. 11B. For example, the wireless power transmission device 101 may control the first switch 122a in the off state 1221 and the second switch 122b in the on state 1221 in the default state (e.g., before a first time point t1), but is not limited thereto. In the off state 1211 of the first switch 122a and the on state 1221 of the second switch 122b, the wireless power transmission device 101 may identify whether the wireless power reception device of the first charging scheme is detected and/or whether the wireless power reception device of the second charging scheme is detected. While the first switch 122a is in the off state 1211 and the second switch 122b is in the on state 1221, power rectified from the rectification circuit 131 may be provided, and accordingly, a component for the second charging scheme may be operated. The wireless power transmission device 101 may identify whether the wireless power reception device of the second charging scheme is detected by operating the component for the second charging scheme.

According to an embodiment or the disclosure, it is assumed that the wireless power reception device of the first charging scheme is detected at the first time point t1. At a first time point t1, the wireless power transmission device 101 may control the first switch 122a in the on state 1212 so that the resonance circuit 121 forms a closed loop, based on detection of the wireless power reception device of the first charging scheme. As the resonance circuit 121 forms a closed loop, the resonance circuit 121 may be used as a repeater. Meanwhile, the wireless power transmission device 101 may control the second switch 122b in the off state 1222 for rapid charging of the wireless power reception device of the first charging scheme. Meanwhile, the wireless power transmission device 101 may perform, e.g., a detection operation of the wireless power reception device of the second charging scheme periodically for a designated time period Δt. For example, the wireless power transmission device 101 may control the second switch 122b in the on state 1223, 1225, 1227, and 1229 for a designated time period Δt, and may control the second switch 122b in the off state 1222, 1224, 1226, and 1228 for other periods. During the designated time period Δt in which the second switch 122b is controlled in the on state 1223, 1225, and 1227, components of the second charging scheme may operate, and the wireless power transmission device 101 may perform a detection operation of the wireless power reception device of the second charging scheme.

Meanwhile, at the second time point t2, it is assumed that the wireless power transmission device 101 detects the wireless power reception device of the second charging scheme. For example, if it is identified that the wireless power transmission device 101 simultaneously charges, e.g., the wireless power reception device of the first charging scheme and the wireless power reception device of the second charging scheme, the on state 1230 of the second switch 122b may be maintained while the on state 1213 of the first switch 122a is maintained. In this case, the wireless power reception device of the first charging scheme and the wireless power reception device of the second charging scheme may be simultaneously charged. Meanwhile, if the wireless power reception device of the first charging scheme is selected as a charging target (or is set to have a higher priority), the first switch 122a may be controlled in the on state and the second switch 122b may be controlled in the off state. Meanwhile, when the wireless power reception device of the second charging scheme is selected as a charging target (or is set to have a higher priority), the first switch 122a may be controlled in the off state and the second switch 122b may be controlled in the on state, but is not limited thereto.

Meanwhile, at the third time point t3, it is assumed that charging stop events, such as a full charge of the wireless power reception device of the first charging scheme and/or an error occurrence of the wireless power reception device of the first charging scheme are identified. Based on the charging stop event, the wireless power transmission device 101 may control the first switch 122a in the off state 1214. The resonance circuit 121 may not form a closed loop. When the wireless power reception device of the second charging scheme is still being charged, the wireless power transmission device 101 may maintain the on state 1231 of the second switch 122b.

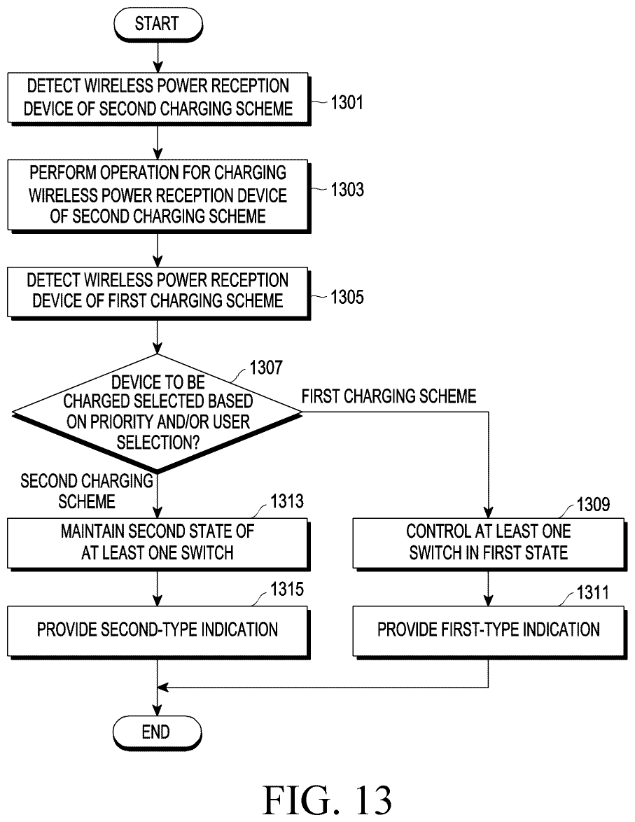

FIG. 13 is a flowchart illustrating a method for operating a wireless power transmission device according to an embodiment of the disclosure.

Referring to FIG. 13, the wireless power transmission device 101 (e.g., the processor 120) may detect the wireless power reception device of the second charging scheme in operation 1301. In operation 1303, the wireless power transmission device 101 may perform an operation for charging the wireless power reception device of the second charging scheme. In operation 1305, the wireless power transmission device 101 may detect the wireless power reception device of the first charging scheme while performing an operation for charging the wireless power reception device of the second charging scheme. As described above, the wireless power transmission device 101 may detect the wireless power reception device of the first charging scheme, based on transmission/reception of a communication signal with the wireless power reception device of the first charging scheme and/or the external wireless power transmission device 11 and/or whether an additional condition is met. Based on detection of the wireless power reception device of the first charging scheme, the wireless power transmission device 101 may select the device to be charged based on the priority and/or the user selection in operation 1307. For example, the priority between the first charging scheme and the second charging scheme may be preset, or may be set based on user selection. For example, the priority may be set based on the current state of the wireless power reception device of the first charging scheme and the wireless power reception device of the second charging scheme. For example, a higher priority may be set for the wireless power reception device having a smaller remaining battery capacity, based on the current remaining battery capacity of the wireless power reception device of the first charging scheme and the wireless power reception device of the second charging scheme, but the type of information used in the current state is not limited. For example, the wireless power transmission device 101 may select a wireless power reception device to perform charging, based on the user's selection.

According to an embodiment or the disclosure, when the first charging scheme is selected, the wireless power transmission device 101 may control the state of the at least one switch 221 in the first state in operation 1309. In operation 1311, the wireless power transmission device 101 may provide a first type indication. The first type indication may be, e.g., an indication indicating that charging of the wireless power reception device of the first charging scheme is performed, but is not limited thereto, and the provision of the first type indication may be omitted. The user may recognize that the wireless power reception device of the second charging scheme is not being charged, based on the first type indication. The wireless power transmission device 101 may stop charging the wireless power reception device of the second charging scheme, based on selection of the wireless power reception device of the first charging scheme. For example, the wireless power transmission device 101 may control the DC/DC converter 141 and/or the conversion circuit 134 not to operate. When the second charging scheme is selected, the wireless power transmission device 101 may control the state of the at least one switch 221 in the second state in operation 1313. In operation 1315, the wireless power transmission device 101 may provide a second type indication. The second type indication may be, e.g., an indication indicating that charging of the wireless power reception device of the second charging scheme is performed, but is not limited thereto, and the provision of the second type indication may be omitted. The wireless power transmission device 101 may stop charging the wireless power reception device of the first charging scheme, based on selection of the wireless power reception device of the second charging scheme. The wireless power transmission device 101 may transmit, e.g., a communication signal instructing to stop charging to the wireless power reception device of the first charging scheme. The wireless power reception device of the first charging scheme receiving the communication signal may control the switch for selectively connecting the reception coil to a load (e.g., the charger) in the off state. Accordingly, the wireless power reception device of the first charging scheme may not absorb electromagnetic waves, and the wireless power reception device of the second charging scheme may be charged at a relatively high speed.

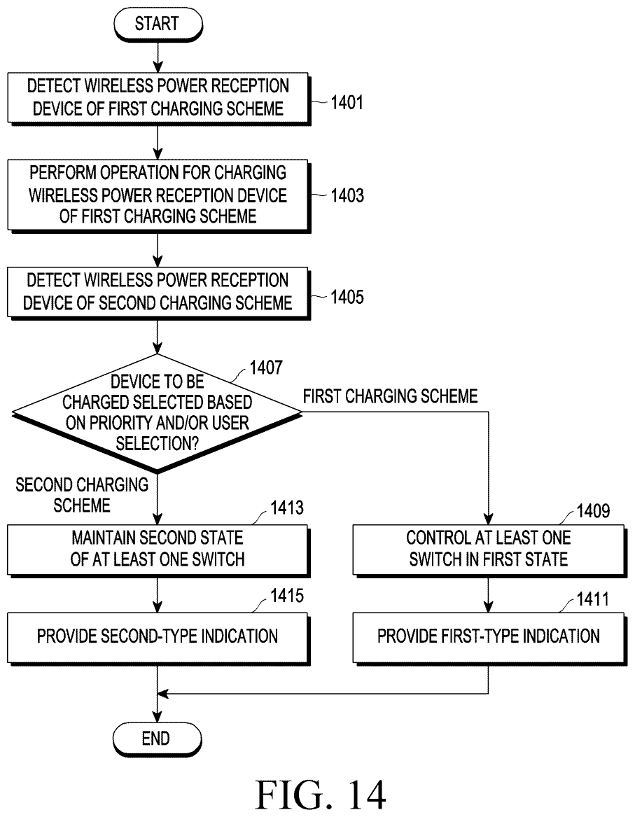

FIG. 14 is a flowchart illustrating a method of operation of a wireless power transmission device according to an embodiment of the disclosure.

Referring to FIG. 14, the wireless power transmission device 101 (e.g., the processor 120) may detect the wireless power reception device of the first charging scheme in operation 1401. In operation 1403, the wireless power transmission device 101 may perform an operation for charging the wireless power reception device of the first charging scheme. In operation 1405, the wireless power transmission device 101 may detect the wireless power reception device of the second charging scheme while performing an operation for charging the wireless power reception device of the first charging scheme. As described above, the wireless power transmission device 101 may continuously or periodically operate the component of the second charging scheme while charging the wireless power reception device of the first charging scheme, and thus may perform a detection operation for the wireless power reception device of the second charging scheme. Based on detection of the wireless power reception device of the first charging scheme, the wireless power transmission device 101 may select the device to be charged based on the priority and/or the user selection in operation 1407. The selection of the device to be charged based on the priority and/or the user selection has been described above with reference to FIG. 13, and thus the detailed description thereof is not repeated.

According to an embodiment or the disclosure, when the first charging scheme is selected, the wireless power transmission device 101 may control the state of the at least one switch 221 in the first state in operation 1409. In operation 1411, the wireless power transmission device 101 may provide a first type indication. The first type indication may be, e.g., an indication indicating that charging of the wireless power reception device of the first charging scheme is performed, but is not limited thereto, and the provision of the first type indication may be omitted. The wireless power transmission device 101 may stop charging the wireless power reception device of the second charging scheme, based on selection of the wireless power reception device of the first charging scheme. When the second charging scheme is selected, the wireless power transmission device 101 may control the state of the at least one switch 221 in the second state in operation 1413. In operation 1415, the wireless power transmission device 101 may provide a second type indication. The second type indication may be, e.g., an indication indicating that charging of the wireless power reception device of the second charging scheme is performed, but is not limited thereto, and the provision of the second type indication may be omitted. The wireless power transmission device 101 may stop charging the wireless power reception device of the first charging scheme, based on selection of the wireless power reception device of the second charging scheme.

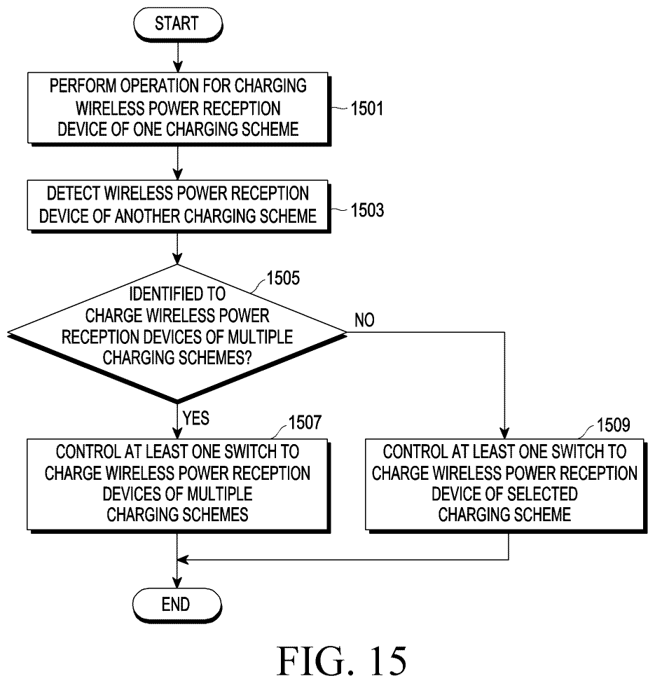

FIG. 15 is a flowchart illustrating a method of operation of a wireless power transmission device according to an embodiment of the disclosure.

Referring to FIG. 15, the wireless power transmission device 101 (e.g., the processor 120) may perform an operation for charging the wireless power reception device of one charging scheme in operation 1501. For example, the wireless power transmission device 101 may perform an operation for charging the wireless power reception device of any one of the first charging scheme or the second charging scheme. In operation 1503, the wireless power transmission device 101 may detect the wireless power reception device of another charging scheme while charging the wireless power reception device of one charging scheme. In operation 1505, the wireless power transmission device 101 may identify whether wireless power reception devices of a plurality of charging schemes are charged. If it is identified that the wireless power reception devices of the plurality of charging schemes are charged (Yes in 1505), the wireless power transmission device 101 may control at least one switch 122 to charge the wireless power reception devices of the plurality of charging schemes in operation 1507. If it is identified that the wireless power reception devices of any one charging scheme are charged (No in 1505), the wireless power transmission device 101 may control the at least one switch 122 to charge the wireless power reception device of the selected charging scheme in operation 1509. For example, as illustrated in FIG. 11A, when the wireless power transmission device 101 includes a first switch 122a, the first switch 122a may be controlled in the on state to perform simultaneous charging, but is not limited thereto. For example, as illustrated in FIG. 11A, when the wireless power transmission device 101 includes the first switch 122a, the first switch 122a may be controlled in the on state to perform charging of the wireless power reception device of the first charging scheme, but is not limited thereto. For example, as illustrated in FIG. 11A, when the wireless power transmission device 101 includes the first switch 122a, the first switch 122a may be controlled in the off state to perform charging of the wireless power reception device of the second charging scheme, but is not limited thereto.

For example, as illustrated in FIG. 11B, when the wireless power transmission device 101 includes the first switch 122a and the second switch 122b, the first switch 122a may be controlled in the on state and the second switch 122b may be controlled in the on state in order to perform simultaneous charging, but is not limited thereto. For example, as illustrated in FIG. 11B, when the wireless power transmission device 101 includes the first switch 122a and the second switch 122b, the first switch 122a may be controlled in the on state and the second switch 122b may be controlled in the off state in order to perform charging of the wireless power reception device of the first charging scheme. For example, as illustrated in FIG. 11B, when the wireless power transmission device 101 includes the first switch 122a and the second switch 122b, the first switch 122a may be controlled in the off state and the second switch 122b may be controlled in the on state in order to perform charging of the wireless power reception device of the second charging scheme.

According to an embodiment or the disclosure, the wireless power transmission device 101 may include a resonance circuit 121 corresponding to a first frequency. The wireless power transmission device 101 may include a rectification circuit 131 configured to rectify first AC power of the first frequency provided from the resonance circuit 121. The wireless power transmission device 101 may include at least one conversion circuit 133 or 134 configured to convert the rectified power into second AC power of a second frequency. The wireless power transmission device 101 may include at least one transmission coil 105 or 107 connected to the at least one conversion circuit 133 or 134, respectively. The wireless power transmission device 101 may include at least one switch 122 connected to the at least one resonance circuit 121. The wireless power transmission device 101 may include a controller 120. The controller 120 may be configured to control the at least one switch 122 so that the resonance circuit 121 forms a closed loop, based on identifying that the first wireless power reception device supporting the first charging scheme based on the first frequency is disposed on at least a portion of at least one charging area of the wireless power transmission device 101. The controller 120 may be configured to control the at least one switch 122 so that the resonance circuit 121 does not form a closed loop, based on identifying that the second wireless power reception device supporting the second charging scheme based on the second frequency is disposed on at least a portion of at least one charging area of the wireless power transmission device 101. The controller 120 may be configured to control at least some of the at least one conversion circuit 133 or 134 to provide the second AC power of the second frequency. The second AC power may be provided to at least some of the at least one transmission coil 105 or 107.

According to an embodiment or the disclosure, the wireless power transmission device 101 may further include a first housing 110 including a coil forming the resonance circuit 121. The first housing 110 may include a first transmission coil 105 of the at least one transmission coil 105 and 107.

According to an embodiment or the disclosure, the wireless power transmission device 101 may further include a second housing 112 different from the first housing 110. The second housing 112 may include a second transmission coil 107 different from the first transmission coil 105 among the at least one transmission coil 105 and 107.

According to an embodiment or the disclosure, the at least one switch 122 may include a first switch 122a, 122aa, or 122ab connected in parallel to the resonance circuit 121.

According to an embodiment or the disclosure, the controller 120 may be configured to control the first switch 122a, 122aa, or 122ab in an on state as at least part of controlling the at least one switch 122 so that the resonance circuit 121 forms the closed loop. The controller 120 may be configured to control the first switch 122a, 122aa, or 122ab in an off state as at least part of controlling the at least one switch 122 so that the resonance circuit 121 does not form the closed loop.

According to an embodiment or the disclosure, the at least one switch 122 may include a first switch 122a, 122aa, or 122ab connected in parallel to the resonance circuit 121 and a second switch 122b, 122ba, or 122bb connected in series between the resonance circuit 121 and the rectification circuit 131.

According to an embodiment or the disclosure, the controller 120 may be configured to control the first switch 122a, 122aa, or 122ab in an on state and the second switch 122b, 122ba, or 122bb in an off state as at least part of controlling the at least one switch 122 to allow the resonance circuit 121 to form the closed loop. The controller 120 may be configured to control the first switch 122a, 122aa, or 122ab in the off state and the second switch 122b, 122ba, or 122bb in the on state, as at least part of controlling the at least one switch 122 to allow the resonance circuit 121 not to form the closed loop.

According to an embodiment or the disclosure, the controller 120 may be configured to control the at least one switch 122 to allow the resonance circuit 121 not to form a closed loop, and control at least some of the at least one conversion circuit 133 or 134 to provide AC power for detection. The controller 120 may be configured to identify whether a second wireless power reception device supporting the second charging scheme is disposed, based on whether at least one condition is met while providing the AC power.

According to an embodiment or the disclosure, the wireless power transmission device 101 may further comprise a communication module supporting short-range communication. The controller 120 may be further configured to identify whether the first wireless power reception device is disposed, based on a communication signal received from an external wireless power transmission device 101 different from the wireless power transmission device 101, through the communication module. The communication signal may include information indicating that the external wireless power transmission device 101 detects the first wireless power reception device.

According to an embodiment or the disclosure, the wireless power transmission device 101 may further comprise a communication module supporting short-range communication. The controller 120 may be further configured to identify whether the first wireless power reception device is disposed, based on a communication signal received from the first wireless power transmission device 101 through the communication module and/or an impedance change for the resonance circuit 121.

According to an embodiment or the disclosure, the controller 120 may be further configured to detect the first wireless power reception device while controlling at least some of the at least one conversion circuit 133 or 134 to provide the second AC power of the second frequency for charging the second wireless power reception device.

According to an embodiment or the disclosure, the controller 120 may be further configured to control an on/off state of the at least one switch 122 corresponding to a selected wireless power reception device based on selection of any one of the first wireless power reception device and the second wireless power reception device.

According to an embodiment or the disclosure, the controller 120 may be further configured to control an on/off state of the at least one switch 122 to allow the resonance circuit 121 to form a closed loop and to provide a portion of an induced electromotive force generated by the resonance circuit 121 to the rectification circuit 131, based on identifying that both the first wireless power reception device and the second wireless power reception device are charged.

According to an embodiment or the disclosure, the controller 120 may be further configured to detect the second wireless power reception device while controlling the at least one switch 122 to form a closed loop based on detection of the first wireless power reception device.

According to an embodiment or the disclosure, the controller 120 may be further configured to control an on/off state of the at least one switch 122 corresponding to a selected wireless power reception device based on selection of any one of the first wireless power reception device and the second wireless power reception device.

According to an embodiment or the disclosure, the controller 120 may be further configured to control an on/off state of the at least one switch 122 to allow the resonance circuit 121 to form a closed loop and to provide a portion of an induced electromotive force generated by the resonance circuit 121 to the rectification circuit 131, based on identifying that both the first wireless power reception device and the second wireless power reception device are charged.

According to an embodiment or the disclosure, a method for operating a wireless power transmission device including a resonance circuit 121 corresponding to a first frequency, a rectification circuit 131 configured to rectify first AC power of the first frequency provided from the resonance circuit 121, at least one conversion circuit 133 or 134 configured to convert the rectified power into second AC power of a second frequency, at least one transmission coil 105 or 107 connected to the at least one conversion circuit 133 or 134 respectively, and at least one switch 122 connected to the at least one resonance circuit may comprise, based on identifying that a first wireless power reception device supporting a first charging scheme based on the first frequency is disposed on at least a portion of at least one charging area of the wireless power transmission device 101, controlling the at least one switch 122 to allow the resonance circuit 121 to form a closed loop. The operation method may comprise controlling the at least one switch 122 so that the resonance circuit 121 does not form a closed loop, based on identifying that the second wireless power reception device supporting the second charging scheme based on the second frequency is disposed on at least a portion of at least one charging area of the wireless power transmission device 101. The operation method may comprise controlling at least some of the at least one conversion circuit 133 or 134 to provide the second AC power of the second frequency. The second AC power may be provided to at least some of the at least one transmission coil 105 or 107.

According to an embodiment or the disclosure, the at least one switch 122 may include a first switch 122a, 122aa, or 122ab connected in parallel to the resonance circuit 121. Controlling the at least one switch 122 to allow the resonance circuit 121 to form the closed loop may control the first switch 122a, 122aa, or 122ab in an on state. Controlling the at least one switch 122 to allow the resonance circuit 121 not to form the closed loop may control the first switch 122a, 122aa, or 122ab in an off state.

According to an embodiment or the disclosure, the at least one switch 122 may include a first switch 122a, 122aa, or 122ab connected in parallel to the resonance circuit 121 and a second switch 122b, 122ba, or 122bb connected in series between the resonance circuit 121 and the rectification circuit 131. Controlling the at least one switch 122 to allow the resonance circuit 121 to form the closed loop may control the first switch 122a, 122aa, or 122ab in an on state and control the second switch 122b, 122ba, or 122bb in an off state. Controlling the at least one switch 122 to allow the resonance circuit 121 not to form the closed loop may control the first switch 122a, 122aa, or 122ab in the off state and the second switch 122b, 122ba, or 122bb in the on state.

According to an embodiment or the disclosure, the operation method may comprise controlling the at least one switch 122 to allow the resonance circuit 121 not to form a closed loop, and control at least some of the at least one conversion circuit 133 or 134 to provide AC power for detection. The operation method may comprise identifying whether a second wireless power reception device supporting the second charging scheme is disposed, based on whether at least one condition is met while providing the AC power.

According to an embodiment or the disclosure, the operation method may comprise identifying whether the first wireless power reception device is disposed, based on a communication signal received from an external wireless power transmission device 101 different from the wireless power transmission device 101, through the communication module. The communication signal may include information indicating that the external wireless power transmission device 101 detects the first wireless power reception device.

According to an embodiment or the disclosure, the operation method may comprise identifying whether the first wireless power reception device is disposed, based on a communication signal received from the first wireless power transmission device 101 through the communication module and/or an impedance change for the resonance circuit 121.

According to an embodiment or the disclosure, the operation method may comprise detecting the first wireless power reception device while controlling at least some of the at least one conversion circuit 133 or 134 to provide the second AC power of the second frequency for charging the second wireless power reception device.

According to an embodiment or the disclosure, the operation method may comprise controlling an on/off state of the at least one switch 122 corresponding to a selected wireless power reception device based on selection of any one of the first wireless power reception device and the second wireless power reception device.

According to an embodiment or the disclosure, the operation method may comprise controlling an on/off state of the at least one switch 122 to allow the resonance circuit 121 to form a closed loop and to provide a portion of an induced electromotive force generated by the resonance circuit 121 to the rectification circuit 131, based on identifying that both the first wireless power reception device and the second wireless power reception device are charged.

According to an embodiment or the disclosure, the operation method may comprise detecting the second wireless power reception device while controlling the at least one switch 122 to form a closed loop based on detection of the first wireless power reception device.

According to an embodiment or the disclosure, the operation method may comprise controlling an on/off state of the at least one switch 122 corresponding to a selected wireless power reception device based on selection of any one of the first wireless power reception device and the second wireless power reception device.

According to an embodiment or the disclosure, the operation method may comprise controlling an on/off state of the at least one switch 122 to allow the resonance circuit 121 to form a closed loop and to provide a portion of an induced electromotive force generated by the resonance circuit 121 to the rectification circuit 131, based on identifying that both the first wireless power reception device and the second wireless power reception device are charged.

The electronic device according to an embodiment or the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment or the disclosure, the module may be implemented in a form of an application-specific integrated circuit (ASIC).

Embodiments as set forth herein may be implemented as software (e.g., the program) including one or more instructions that are stored in a storage medium (e.g., internal memory or external memory) that is readable by a machine (e.g., the wireless power transmission device 101). For example, a processor (e.g., the processor 120) of the machine (e.g., the wireless power transmission device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment or the disclosure, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment or the disclosure, each component (e.g., a module or a program) of the above-described components may include a single entity or multiple entities. Some of the plurality of entities may be separately disposed in different components. According to an embodiment or the disclosure, one or more of the above-described components may be omitted, or one or more other components may be added. Alternatively or additionally, a plurality of components (e.g., modules or programs) may be integrated into a single component. In such a case, according to various embodiments or the disclosure, the integrated component may still perform one or more functions of each of the plurality of components in the same or similar manner as they are performed by a corresponding one of the plurality of components before the integration. According to various embodiments or the disclosure, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A wireless power transmission device comprising:
a resonance circuit corresponding to a first frequency;
a rectification circuit configured to rectify first alternating current (AC) power of the first frequency provided from the resonance circuit;
at least one conversion circuit configured to convert the rectified power into second AC power of a second frequency;
at least one transmission coil connected to the at least one conversion circuit respectively;
at least one switch connected to the resonance circuit;
memory storing one or more computer programs; and
one or more processors communicatively coupled to the memory,
wherein, based on identifying that a first wireless power reception device supporting a first charging scheme based on the first frequency is disposed on at least a portion of at least one charging area of the wireless power transmission device, the one or more computer programs include computer-executable instructions that, when executed by the one or more processors individually or collectively, cause the wireless power transmission device to:
control the at least one switch to allow the resonance circuit to form a closed loop, and
wherein, based on identifying that a second wireless power reception device supporting a second charging scheme based on the second frequency is disposed on at least a portion of the at least one charging area of the wireless power transmission device, the one or more computer programs include computer-executable instructions that, when executed by the one or more processors individually or collectively, cause the wireless power transmission device to:
control the at least one switch to allow the resonance circuit not to form the closed loop, and
control at least some of the at least one conversion circuit to provide the second AC power of the second frequency, wherein the second AC power is provided to at least some of the at least one transmission coil.

2. The wireless power transmission device of claim 1, further comprising:
a first housing including a coil forming the resonance circuit,
wherein the first housing includes a first transmission coil of the at least one transmission coil.

3. The wireless power transmission device of claim 2, further comprising:
a second housing different from the first housing,
wherein the second housing includes a second transmission coil different from the first transmission coil, of the at least one transmission coil.

4. The wireless power transmission device of claim 1, wherein the at least one switch includes a first switch connected in parallel to the resonance circuit.

5. The wireless power transmission device of claim 1,
wherein the one or more computer programs further include computer-executable instructions that, when executed by the one or more processors individually or collectively, cause the wireless power transmission device to control the first switch in an on state as at least part of controlling the at least one switch to allow the resonance circuit to form the closed loop, and
wherein the one or more computer programs further include computer-executable instructions that, when executed by the one or more processors individually or collectively, cause the wireless power transmission device to control the first switch in an off state as at least part of controlling the at least one switch to allow the resonance circuit not to form the closed loop.

6. The wireless power transmission device of claim 1, wherein the at least one switch includes:
a first switch connected in parallel to the resonance circuit; and
a second switch connected in series between the resonance circuit and the rectification circuit.

7. The wireless power transmission device of claim 1, wherein the one or more computer programs further include computer-executable instructions that, when executed by the one or more processors individually or collectively, cause the wireless power transmission device to:
control the first switch in an on state and the second switch in an off state as at least part of controlling the at least one switch to allow the resonance circuit to form the closed loop, and
control the first switch in the off state and the second switch in the on state, as at least part of controlling the at least one switch to allow the resonance circuit not to form the closed loop.

8. The wireless power transmission device of claim 1, wherein the one or more computer programs further include computer-executable instructions that, when executed by the one or more processors individually or collectively, cause the wireless power transmission device to:
control the at least one switch to allow the resonance circuit not to form a closed loop, and control at least some of the at least one conversion circuit to provide AC power for detection; and
identify whether a second wireless power reception device supporting the second charging scheme is disposed, based on whether at least one condition is met while providing the AC power.

9. The wireless power transmission device of claim 1, further comprising:
a communication module supporting short-range communication,
wherein the one or more computer programs further include computer-executable instructions that, when executed by the one or more processors individually or collectively, cause the wireless power transmission device to:
identify whether the first wireless power reception device is disposed, based on a communication signal received from an external wireless power transmission device different from the wireless power transmission device, through the communication module, and
wherein the communication signal includes information indicating that the external wireless power transmission device detects the first wireless power reception device.

10. The wireless power transmission device of claim 1, further comprising:
a communication module supporting short-range communication,
wherein the one or more computer programs further include computer-executable instructions that, when executed by the one or more processors individually or collectively, cause the wireless power transmission device to:
identify whether the first wireless power reception device is disposed, based on a communication signal received from the wireless power transmission device through the communication module and/or an impedance change for the resonance circuit.

11. The wireless power transmission device of claim 1, wherein the one or more computer programs further include computer-executable instructions that, when executed by the one or more processors individually or collectively, cause the wireless power transmission device to detect the first wireless power reception device while controlling at least some of the at least one conversion circuit to provide the second AC power of the second frequency for charging the second wireless power reception device.

12. The wireless power transmission device of claim 1, wherein the one or more computer programs further include computer-executable instructions that, when executed by the one or more processors individually or collectively, cause the wireless power transmission device to control an on/off state of the at least one switch corresponding to a selected wireless power reception device based on selection of any one of the first wireless power reception device and the second wireless power reception device.

13. The wireless power transmission device of claim 1, wherein the one or more computer programs further include computer-executable instructions that, when executed by the one or more processors individually or collectively, cause the wireless power transmission device to:
control an on/off state of the at least one switch to allow the resonance circuit to form a closed loop; and
provide a portion of an induced electromotive force generated by the resonance circuit to the rectification circuit, based on identifying that both the first wireless power reception device and the second wireless power reception device are charged.

14. The wireless power transmission device of claim 1, wherein the one or more computer programs further include computer-executable instructions that, when executed by the one or more processors individually or collectively, cause the wireless power transmission device to detect the second wireless power reception device while controlling the at least one switch to form a closed loop based on detection of the first wireless power reception device.

15. A method for operating a wireless power transmission device including:
a resonance circuit corresponding to a first frequency;
a rectification circuit configured to rectify first alternating current (AC) power of the first frequency provided from the resonance circuit;
at least one conversion circuit configured to convert the rectified power into second AC power of a second frequency;
at least one transmission coil connected to the at least one conversion circuit respectively; and
at least one switch connected to the resonance circuit, the method comprising:
based on identifying that a first wireless power reception device supporting a first charging scheme based on the first frequency is disposed on at least a portion of at least one charging area of the wireless power transmission device, controlling the at least one switch to allow the resonance circuit to form a closed loop,
based on identifying that a second wireless power reception device supporting a second charging scheme based on the second frequency is disposed on at least a portion of the at least one charging area of the wireless power transmission device,
controlling the at least one switch to allow the resonance circuit not to form the closed loop, and
controlling at least some of the at least one conversion circuit to provide the second AC power of the second frequency, wherein the second AC power is provided to at least some of the at least one transmission coil.

16. The method of claim 15, further comprising:
controlling the first switch in an on state as at least part of controlling the at least one switch to allow the resonance circuit to form the closed loop; and
controlling the first switch in an off state as at least part of controlling the at least one switch to allow the resonance circuit not to form the closed loop.

17. The method of claim 15, further comprising:
controlling the first switch in an on state and the second switch in an off state as at least part of controlling the at least one switch to allow the resonance circuit to form the closed loop, and
controlling the first switch in the off state and the second switch in the on state, as at least part of controlling the at least one switch to allow the resonance circuit not to form the closed loop.

18. The wireless power transmission device of claim 1, further comprising:
controlling the at least one switch to allow the resonance circuit not to form a closed loop, and control at least some of the at least one conversion circuit to provide AC power for detection; and
identifying whether a second wireless power reception device supporting the second charging scheme is disposed, based on whether at least one condition is met while providing the AC power.

19. One or more non-transitory computer-readable storage media storing computer-executable instructions that, when executed by one or more processors individually or collectively, cause a wireless power transmission device to perform operations, the wireless power transmission device including:
a resonance circuit corresponding to a first frequency;
a rectification circuit configured to rectify first alternating current (AC) power of the first frequency provided from the resonance circuit;
at least one conversion circuit configured to convert the rectified power into second AC power of a second frequency;
at least one transmission coil connected to the at least one conversion circuit respectively; and
at least one switch connected to the resonance circuit,
the operations comprising:
based on identifying that a first wireless power reception device supporting a first charging scheme based on the first frequency is disposed on at least a portion of at least one charging area of the wireless power transmission device, controlling the at least one switch to allow the resonance circuit to form a closed loop,
based on identifying that a second wireless power reception device supporting a second charging scheme based on the second frequency is disposed on at least a portion of the at least one charging area of the wireless power transmission device,
controlling the at least one switch to allow the resonance circuit not to form the closed loop, and
controlling at least some of the at least one conversion circuit to provide the second AC power of the second frequency, wherein the second AC power is provided to at least some of the at least one transmission coil.

20. The one or more non-transitory computer-readable storage media of claim 19, the operations further comprising:
controlling the first switch in an on state as at least part of controlling the at least one switch to allow the resonance circuit to form the closed loop; and
controlling the first switch in an off state as at least part of controlling the at least one switch to allow the resonance circuit not to form the closed loop.
